(19) United States
(12) Patent Application Publication
(10) Pub. No.: US 2008/0270328 A1
(43) Pub. Date: Oct. 30, 2008

(54) Building and Using Intelligent Software Agents For Optimizing Oil And Gas Wells

(76) Inventors: Chad Lafferty, Atlanta, GA (US); Neil De Guzman, Houston, TX (US); Lawrence Lafferty, Atlanta, GA (US); Donald K. Steinman, Missouri City, TX (US)

Correspondence Address: Law Offices of Tim Headley, 7941 Katy Fwy, Suite 506, Houston, TX, 77024-1924, US

(21) Appl. No.: 11/871,156

(22) Filed: Oct. 12, 2007

Related U.S. Application Data
(60) Provisional application No. 60/852,269, filed on Oct. 18, 2006.

(51) Int. Cl. G06F 15/18; G06F 15/00

(52) U.S. Cl. 706/12; 702/183

(57) ABSTRACT

A system and method for monitoring processes in the production of oil and gas uses intelligent software agents employing associative memory techniques that receive data from sensors in the production environment and from other sources and perform pattern matching operations to identify normal and abnormal behavior of the well production. The agents report the behaviors to human operators or other software systems. The abnormal behavior may consist of any behavior of the production processes that is other than the desired behavior of the well. The intelligent software agents are trained to identify both specific behaviors and behaviors that have never before been observed and recognized in the well.

### CROSS-REFERENCES TO RELATED APPLICATIONS

This patent application claims the benefit of provisional patent application serial number 60852269, filed Oct. 18, 2006, entitled “System and Method for Using Intelligent Software Agents for Optimization of Oil and Gas Wells”, and listing as the inventors: Neil De Guzman, Chad Lafferty, Lawrence Lafferty, and Donald Steinman. Related applications include: “Method to Optimize Production from a Gas-lifted Oil Well”, Ser. No. 11/678,353, filed Mar. 13, 2007, and “Method Of Managing Multiple Wells In A Reservoir”, U.S. Pat. No. 7,266,456, issued Sep. 4, 2007.

### STATEMENT REGARDING FEDERALLY SPONSORED RESEARCH OR DEVELOPMENT

None.

### REFERENCE TO A “SEQUENCE LISTING,” A TABLE, OR A COMPUTER PROGRAM LISTING APPENDIX SUBMITTED ON A COMPACT DISC AND AN INCORPORATION BY REFERENCE OF THE MATERIAL ON THE COMPACT DISC

None.

### BACKGROUND OF THE INVENTION

(1) Field of the Invention

The invention relates to the use of intelligent agents for automated surveillance and control of processes and operations in oil and gas wells.

(2) Description of the Related Art

There are numerous systems and software programs whose objective it is to optimize oil and gas production periodically from an apparatus designed to manage wells and often to provide artificial lift of oil. There are devices located in wells to provide gas lift, and various types of pumping systems, e.g., electric submersible pumps, and progressive cavity pumps. There are systems designed to push the oil and gas out of the reservoir. These systems are used when the natural forces of the reservoir are no longer adequate to push the hydrocarbons to the surface. The most common of these systems are water flooding, CO2 injection, and steam injection each of which is designed to address particular conditions in the reservoir. Plunger lift systems are a popular way to deliquify gas wells. Chemical injection is used to treat a gas well when it starts to load with liquid. Riser-gas lift systems are used to help bring oil to the surface in sub sea wells.

It has always been difficult to control these systems and optimize their efficiency. There are too many variables representing complex dynamic situations in the reservoir for operators to keep track of and take action in a relevant time frame.

There are new tools which provide the possibility of better management of wells. More sensors are being used to instrument specific parts of processes today. Computers store the data associated with individual sensors. These data may be analyzed and associations discovered between different sensors and other attributes that are recorded or calculated from system information. However, these sensors create vast amounts of data which cannot be processed in a time frame needed to know what action to take modify well controls and improve the performance of the well.

In order to control production effectively, one problem is how to build software agents from databases, deploy the agents for use in system surveillance and control, enable the agents to learn from the behavior of the system, and use the learning to adapt the agent to a different level of performance. The combination of these demands makes it extremely difficult and expensive to build multiple agents.

Numerous databases contain different records in structured and unstructured form that can be analyzed to discover associations and from which patterns can be created to represent differing behaviors of the system. The different patterns can be incorporated into one or several agents to discover the relationships in the system behavior. The problem is how to take advantage of the information contained in the databases efficiently without complex and time consuming analysis performed by persons with advanced training in math or computer science in conjunction with experts versed in the particular domain to be studied.

There are many situations in which less than optimal production from the well may occur. These situations involve the pressure, temperature, production flow, gas injection rates, and the states of the several valves in the well. In order to diagnose a problem, it is necessary to consider many configurations of these parameters and the implications of their current values. Further, it is necessary to classify possible states of the oil well in order that the diagnostic can relate to the existing production state of the well.

Several attempts have been made to optimize oil well liquid production under gas-lift that are based on so-called expert systems that use a rules-based decision making process to identify problems with the way in which a gas-lift technique is performing on a given well. Such expert systems may not perform as well as needed because the full set of data values required for making an incontrovertible diagnosis may not be available. Accordingly the system must be able to diagnose problems using whatever data is available. Also, such expert systems may not diagnose lifting problems correctly because the parameters of the operation change during the life of the well. In order to account for the aging of the well, the expert system would require continuous or intermittent retuning to ensure effective diagnostic abilities. In addition, many factors that influence the ability to diagnose problems in a well under gas-lift are often overlooked by the expert system because the developers of the systems cannot know all possible conditions that may influence the operation at the time that they develop the software program.

An early expert system that used a rules-based decision making process which attempted to improve the rules based on the results obtained is disclosed in the following patent, which is incorporated herein by this reference: U.S. Pat. No. 4,918,620, which states in the abstract, “A computer software architecture and operating method for an expert system that performs rule-based reasoning as well as a quantitative analysis, based on information provided by the user during a user session, and provides an expert system recommendation embodying the results of the quantitative analysis are disclosed. In the preferred embodiment of the invention, the expert system includes the important optional feature of modifying its reasoning process upon finding the quantitative analysis results unacceptable in comparison to predetermined acceptance criteria.”. However, the method disclosed in this patent does not allow for generating attributes from real time data to compare to known symptoms of poor well behaviors. Rather, it requires that an expert think of all the rules possible in the system in order to account for novel behavior, and it cannot adapt to data-drop-out when sensors fail in service.

Another expert system that uses a rules-based decision making process that attempts to improve the rules based on the results obtained is disclosed in the following patent, which is incorporated herein by this reference: U.S. Pat. No. 6,529,893, which states in the abstract, “The system uses an author interface, an inference generator, and a user interface to draw authoring and diagnostic inferences based on expert and user input. The inference generator includes a knowledge base containing general failure attribute information. The inference generator allows the expert system to provide experts and users with suggestions relating to the particular task at hand.” However, the method disclosed in this patent does not show how to deploy an expert system to diagnose problems with gas-lift wells, and it is furthermore subject to the limitations of rule-based-systems as described in the previous paragraph.

Another expert system that uses a rules-based decision making process which attempts to improve the rules based on the results obtained is disclosed in the following patent, which is incorporated herein by this reference: U.S. Pat. No. 6,535,863, which states in the abstract, “The method improves the performance of the system by evaluating how well the system's body of knowledge solves/performs a problem/task and verifying and/or altering the body of knowledge based upon the evaluation”. However, the method disclosed in this patent does not address monitoring and diagnosis. Also, it requires a human to evaluate the results of the analysis, and provide feedback to the software program regarding which rules to accept and which to keep based on performance.

Another expert system that uses a knowledge-based decision making process that attempts to improve the base of knowledge based on the results obtained is disclosed in the following published patent application, which is incorporated herein by this reference: U.S. Pat. No. 7,177,787, which states in the detailed description, “The weights of each network or expert are determined at the end of a learning stage; during this stage, the networks are supplied with a set of data forming their learning base, and the configuration and the weights of the network are optimized by minimizing errors observed for all the samples of the base, between the output data resulting from network calculation and the data expected at the output, given by the base.” However, the method disclosed in this patent requires an accurate model of flow in the system in order to train it, and it will not diagnose the origin of flow impairments.

Another expert system that uses a knowledge-based decision making process that attempts to improve the base of knowledge based on the results obtained is disclosed in the following patent, which is incorporated herein by this reference: U.S. Pat. No. 6,236,894, which states in the abstract, “A genetic algorithm is used to generate, and iteratively evaluate solution vectors, which are combinations of field operating parameters such as incremental gas-oil ratio cutoff and formation gas-oil ratio cutoff values. The evaluation includes the operation of an adaptive network to determine production header pressures, followed by modification of well output estimates to account for changes in the production header pressure.” However, the method disclosed in this patent does not address individual well productivity, and it requires iterative applications rather than recognizing and diagnosing problems from the data presented.

Another expert system that uses a knowledge-based decision making process that attempts to improve the base of knowledge based on the results obtained is disclosed in the following patent, which is incorporated herein by this reference: U.S. Pat. No. 6,434,435, which states in the abstract, “The systems and the methods utilize intelligent software objects which exhibit automatic adaptive optimization behavior. The systems and the methods can be used to automatically manage hydrocarbon production in accordance with one or more production management goals using one or more adaptable software models of the production processes.” However, the method disclosed in this patent requires production models of the production process, which is itself subject to errors. Therefore, the system disclosed in the '435 patent will not be fault tolerant of failed or missing sensor data. Furthermore, the system disclosed in the '435 patent does not produce a specific diagnosis of unsatisfactory behavior.

Therefore, the art is seeking tools designed to overcome the problems of building a series of agents that may be used for surveillance, monitoring, control, and acting in real time upon the behavior of a system. Needed is an application development tool that can be used to develop and modify intelligent software agents to operate as event recognizers on user defined data sets. These data sets may include any combination of both numeric and text data from multiple data sources including raw and processed sensor data, electronic reporting and independent models. It would be best if the data were analysed using an associative-memory pattern recognizer. Such a pattern recognition engine would be best if it could be used with any combination of generic and situation specific pattern memories.

### BRIEF SUMMARY OF THE INVENTION

A system and method for monitoring processes in the production of oil and gas, comprising intelligent software agents employing associative memory techniques that receive data from sensors in the production environment and from other sources and performs pattern matching operations to identify normal and abnormal behavior of said oil and gas production from a well and reporting said behaviors to human operators or other software systems wherein the abnormal behavior may consist of any behavior of the production processes that is other than the desired behavior of the well, and wherein the intelligent software agents are trained to identify both specific behaviors and behaviors that have never before been observed and recognized in the well.

The present invention is a system and method of using associative memory techniques to recognize patterns in time series data and other data sources and to report such patterns to human operators or other software control systems.

It is a further feature of the present invention that the process being monitored is from oil and gas wells that are naturally lifted.

It is a further feature of the present invention that the process being monitored is from oil and gas wells that are artificially lifted.

It is another feature of the present invention that the associative memory engine can be trained on existing data patterns quickly and inexpensively using a subject of this invention called the agent builder.

It is another feature of the present invention that signal processing techniques are used to condition raw input time series data streams into attributes that can be searched for patterns by the associative memory software.

It is still a further feature of the present invention that the intelligent agent formed using the associative memory technique also uses a concept graph to integrate information from several associative memories together with logic processes to infer conditions in the production process.

It is still a further feature of the present invention that the intelligent agent formed using the associative memory technique employs libraries of agents previously trained on other wells to monitor processes on a given well.

It is still a further feature of the present invention that the intelligent agent formed using the associative memory technique uses both absolute values of attributes of the well data stream and relative values of those sensor signals.

It is still a further feature of the present invention that the intelligent agent formed using the associative memory technique can be taught to recognize when its own training data are no longer representative of the conditions currently being monitored and when the memory must be retrained to present conditions.

### BRIEF DESCRIPTION OF THE SEVERAL VIEWS OF THE DRAWINGS

FIG. 1 is an illustration of data traces being monitored.

FIG. 2 is an event recognition processing flow.

FIG. 3 is an illustration of an associative memory after one observation.

FIG. 4 is an illustration of an associative memory after four observations.

FIG. 5 is an illustration of a concept graph for the case of sand production surveillance.

FIG. 6 is a flow chart symbolic of data conditioning processing flow.

FIG. 7 is an example of how the agent can both diagnose problematic behavior and explain to the user why it made a particular choice of behaviors in its report.

FIG. 8 is an event recognizer processing flow as applied to the agent builder.

FIG. 9 is a basic screen layout of the agent builder.

FIG. 10 is a screen shot showing the short cuts, scrolling bars, and the agent selector.

FIG. 11 is a screen shot showing the Agent Manager Control Panel.

FIG. 12 is a screen shot showing the Schema Manager.

FIG. 13 is a screen shot showing how attributes of the data are edited and prepared for recognition in the associative memory.

FIG. 14 is a screen shot showing how to modify the agent builder's graphics properties for its X-axis.

FIG. 15 is a screen shot showing how to modify the agent builder's graphics properties for its Y-axis.

FIG. 16 is a screen shot showing how to modify the agent builder's trace color properties.

FIG. 17 is a screen shot showing how to select regions of the time domain data on which to train the agent.

FIG. 18 is a screen shot showing how to import data into the agent.

FIG. 19 is a screen shot showing how to edit the data handling Schema.

FIG. 20 is a screen shot showing how to apply the signal conditioning algorithms.

FIG. 21 is a screen shot showing how to engage the “Observe” dialog box.

FIG. 22 is a screen shot showing how to use the “Response Query” dialog box.

FIG. 23 is a screen shot showing results from a “Response Query”.

### DETAILED DESCRIPTION OF THE INVENTION

1. Core Event Recognizer Concepts

Fundamental to the present invention is that the intelligent agents provide an assessment of the environment of a process that one wishes to monitor. In that environment, the software agent searches for “events” that indicate proper or dysfunctional behavior of the oil or gas well. An event recognizer's primary function in a surveillance system is to monitor data arriving in real-time from a well's sensors and other data sources such as daily reports and periodic well test, with the intent of detecting anomalies in the data stream that indicate both normal functioning and problems in the well.

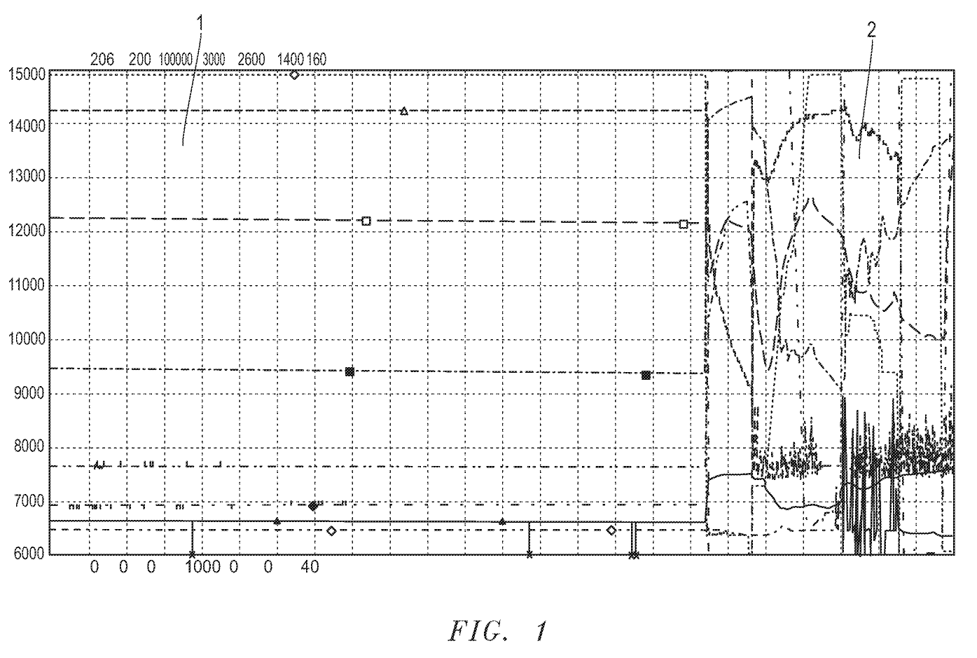

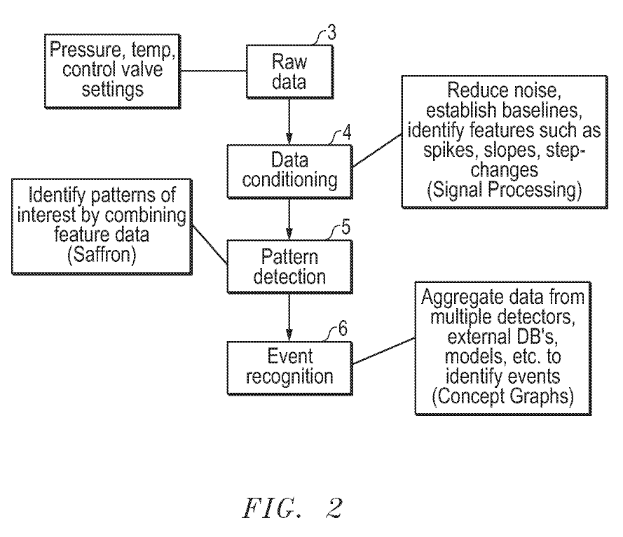

FIG. 1, an example of a well which has experienced a sand failure, illustrates the problem. Note the relatively stable data channels in the region 1 to the left of the graphic and the chaotic traces on the right in the region denoted by 2. Operators responsible for monitoring high-value assets spend much of their time looking at data streams such as this example, which happens to be quite dramatic. As illustrated in the figure, the operator's task is fundamentally visual pattern recognition across multiple data channels.

In a trace like FIG. 1, operators can see features that signify what is happening—features such as a subtle increase in well head temperature, more dramatic increases in down hole pressure and corresponding decreases in well head pressure. Surveillance engineers can “see” the features in individual data channels, and they can combine features from multiple data channels to arrive at an interpretation of a well's state.

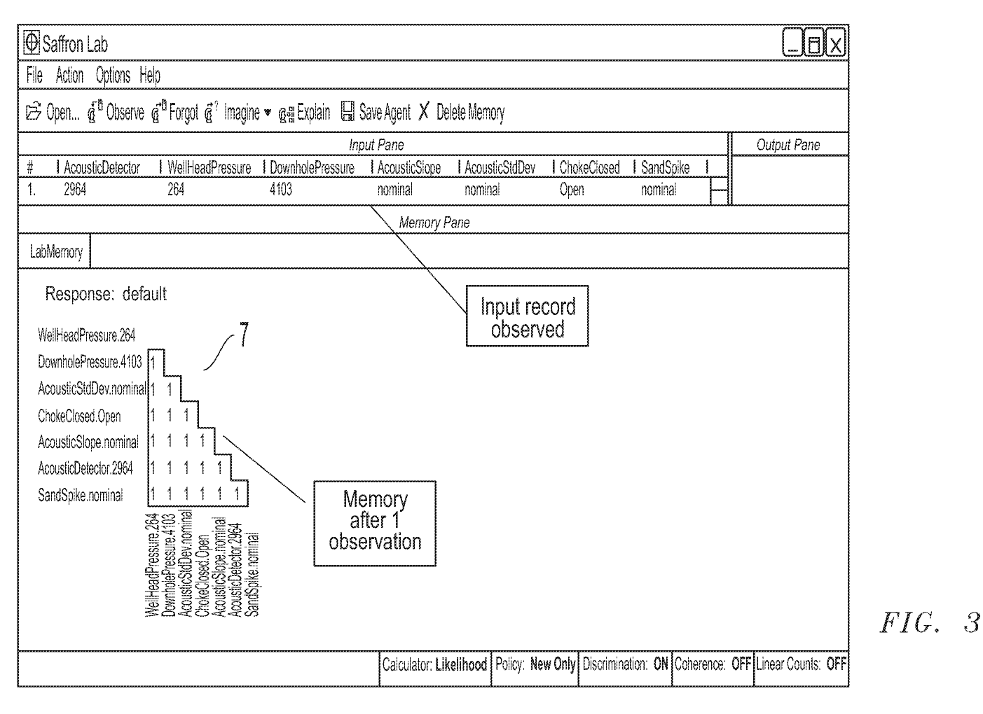

Event recognizers function in a similar manner and allow replacement of the human operator by the computers running the software embodiment of the present invention. FIG. 2 illustrates the approach.

Processing begins with raw data 3 such as pressure and temperature values from a producing well. This is typically a continuous data stream, provided at intervals that may range from every few seconds to every few minutes. However, it may also entail data from “morning reports” or periodic well tests.

During data conditioning 4, a set of signal processing algorithms is applied to identify features such as spikes, slopes, and step-changes. More advanced algorithms such as Fourier transforms are also used to characterize data channels as they vary over time.

The features and attributes generated during data conditioning flow into an associative memory program, a pattern recognition 5 engine. This engine can distinguish between patterns that appear normal and patterns that are anomalies that have been observed before. An event recognizer is typically configured with several pattern recognizers; each one specialized to perform a well-defined function.

The results generated by all of the pattern detectors are aggregated during event recognition 6. This step enables integration of data from multiple detectors, external algorithms, and components such as models. Event recognition produces definitive values for the well's current state.

The discussion below illustrates the use of signal processing applied to raw data streams from sensors on the wells and on flow-lines to wells. The signal processing techniques used in the present invention may be modified or augmented to satisfy the functional requirements of different application agents, e.g., beam pump, gas lift, electrical submersible pumps using particular mathematical functions that are well known to persons skilled in the arts of those disciplines.

One or more conditioning processes may be applied to each of the one or more input data channels, e.g., the well's down hole pressure, well head temperature, gas injection rate or any other available data channel. Signal processing generates attributes that are presented to the associative memory engine to detect and classify patterns. Each of the titles below addresses processing on a data stream or streams to yield an attribute. These processes are called conditioners. A representative set of conditioners is described in the following paragraphs.

Baseline

The baseline is the average of several previous values observed on a data channel. If, for example, one elects to use the previous 200 values, the standard deviation of the previous 200 values is taken and used for the standard deviations over baseline conditioner. The baseline starts being calculated when 200 values have been received on the data channel and is recalculated for each iteration afterward.

The threshold used with various other detectors is calculated the first time after 200 values are received and then for a larger number of iterations afterward. If, for example, 10,000 values are chosen to form the larger number of iterations, the previous 10,000 data values are used to calculate the threshold with the exception of the first iteration that only uses 200 data values. These 10,000 values are divided into subsets of 100 values that are sorted into ascending order. The 50th value of each of these subsets is subtracted from the other values in the subset. Then, a standard deviation is calculated with the adjusted values and any of these values that falls within one standard deviation is used to find the threshold, which is the standard deviation of the second group of adjusted values. Clearly, the use of 200 values for the first test and 10,000 values for the more definitive set is a judgment made by a particular practitioner for a particular data set. Any suitable set of numbers can be used for other conditions, and the efficacy of the invention does not depend on the particular numbers chosen.

A delta takes a previous data value and subtracts it from the current data value. The user provides a source attribute and a number that defines the location of the previous data value that is to be subtracted from the current value, called the step. The step needs to be a minimum of 1, which is the previous value, and has no maximum.

Integral

The integral calculator conditioner uses the current value and a set of previous values determined by the user. Each concurrent pair of values is averaged and added to a global result which is reported by the conditioner. For example, the current value and the previous value are averaged and added to the average of the previous value and the value before it.

Integral Over Baseline

The integral over baseline conditioner takes the standard deviation of the last several values and multiplies it by two. Then the Integral Calculator conditioner takes the value and performs the operation explained in the Integral Calculator conditioning process.

Long Term Value

The long term value creates a new attribute from the user-selected source value and step size, which is the location of the desired data value. The value does not have any type of calculations performed on it and is the actual value from the source channel.

Mapping Values

Attributes can be created that report a particular value when other attributes satisfy the specific conditions set up by the user.

Math

Several math functions are available to use on the different attributes, including standard mathematics, statistical functions, and trigonometry functions.

Percent Delta

The percent delta conditioner is calculated and set up the same way as the delta conditioner with the exception that the previous value is divided into the result of the subtraction of the current data value and the previous data value.

Rename

The rename conditioner puts the current source data value specified by the user into a new attribute defined by the user.

Sand Detector

The sand detector incorporates a series of selectable histograms and a sand counter that reviews and sorts data acquired over a user selectable past time period. The histograms include one that separates degrees of sand spike amplitudes, the daily durations of spikes, weekly duration of spikes, and the monthly durations of spikes.

The amplitude histogram is divided into three sections: low, medium, and high. The low histogram holds the number of spikes in the range of 1 to 3 percent over the baseline, the medium histogram contains the number of spikes in the range of 3 to 15 percent over the baseline, and the high histogram contains the number of spikes that are greater than 15 percent over the baseline.

Each of the duration histograms has four sections associated with it: short, medium, long, and total. The short histogram contains any continuous spikes between 1 and 3 records long, the medium histogram shows the continuous spikes between 3 and 12 records long, and the long histogram has the continuous spikes that are greater than 12 records long. The total histogram is the sum of the values in the short, medium, and long histograms. Each set of histograms keeps track of only the values for the previous time period (perhaps one day), a longer time period (perhaps the past seven days), or longer (for example, the previous twenty-eight days for the day, week, and month histograms, respectively).

The actual sand detector value returns a 0, 1, or −1 depending on if there is no sand spike, a positive sand spike, or a negative sand spike. The weekly sand counter keeps track of how much sand has passed into the well for the last seven days.

For all the histograms, the sand detector, and the weekly sand counter, only detections that are over a user selectable number of standard deviations above baseline are counted.

Slope Detector

The slope detector is attached to a data channel and determines if there is a change in slope and the magnitude of the slope. The slope detector's value ranges from −3 to +3 depending on the degree of the slope.

Spike Detector

This detector looks for spikes of four sizes: 5, 10, 20, and 50 point. Three values are taken: the last known value (latest), the value being calculated for (current), and the value at the beginning of the possible spike (early). For example, on the 10 point spike detector the latest value is the value most recently received, the current value is the value with index of 10, and the early value is the value with the index of 20. The values between the early and latest values are compared to the current value, if the values are all lower or all higher than the current value, a peak has been considered found. Next, one of two conditions must be true to be considered a valid spike, Condition 1 is that the current value minus the early value is greater than the threshold times 15 and the late value minus the current value is less than 15 times the negative of the threshold. Condition 2 is that the current value minus the early value is less than 15 times the negative of the threshold, and the late value minus the current value is greater than 15 times the threshold. If one of these two conditions is true and a peak has been detected then a spike will be reported for the particular size.

Values Returned:
0—no spike detected
1—spike detection occurred

Step Detector

The step detector conditioner creates a new attribute that reports whether or not a change has occurred in a data channel.

The step detector looks at the previous value in the channel and compares it to the current value. If there is a positive change than the attribute reports a positive one, a negative change reports a negative one, and no change reports a zero.

Standard Deviations from Baseline

Using the baseline and the standard deviation calculated by the long term tracking conditioner, the standard deviations from baseline creates a new attribute that reports how many standard deviations the current value is within. For example if the current data value is 2.56 standard deviations from baseline then 3 is reported for the attribute. The output from the conditioner will report negative numbers if the current value is less than the baseline.

Window

The window conditioner will create new attributes for the specified number of previous values of the source.

Associative Memories

In addition to the mathematical algorithms used during data conditioning, a core component used during event recognition is an associative memory such as used, for example, in the intelligence community. First envisioned in the late 1940's, associative memories provide machine learning and pattern recognition functions that are analogous to human capabilities. Associative memories “learn” by storing data and the relationships between data elements in a compressed format that facilitates pattern recognition. Associative memories are truly memories—they remember what they are taught. Associative memories are designed to handle very large data sets.

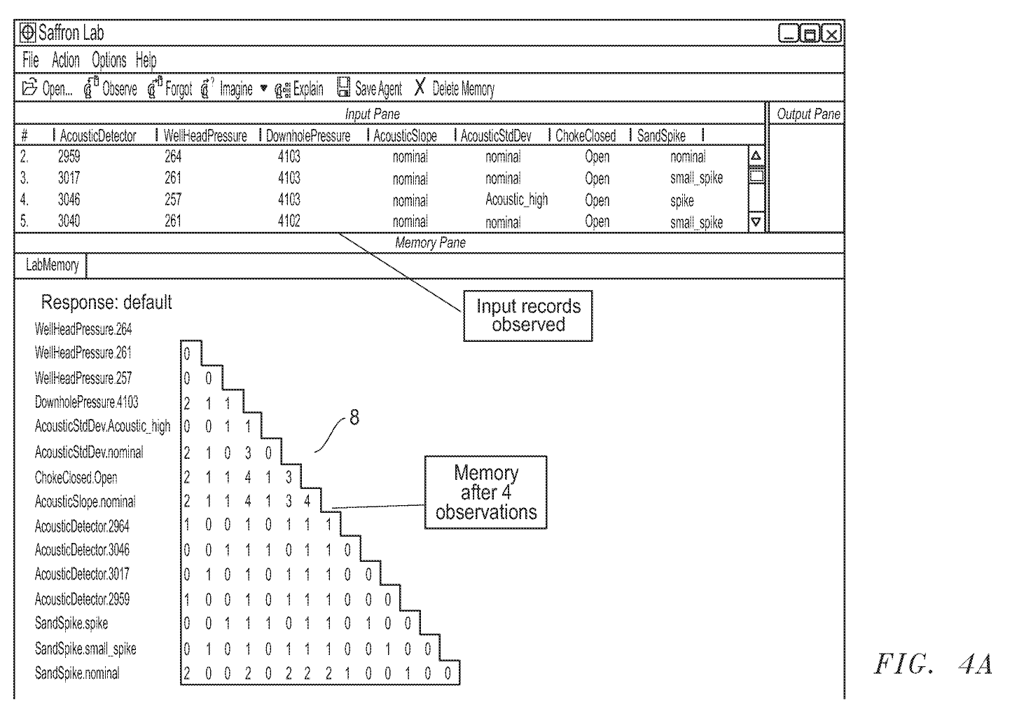

Associative memories keep track of the co-occurrences between attributes and values in a structure known as a co-occurrence matrix. FIG. 3 illustrates an associative memory that is storing information about a well's downhole pressure, wellhead pressure, acoustic sensor, and so on. Each attribute and its corresponding value is an attribute-value pair 7. Thus, WellheadPressure with a value of 264 (Wellhead Pressure: 264) and WellheadPressure with a value of 261 (WellheadPressure: 261) are two different attribute value pairs. The matrix 7 stores a count of the number of times each attribute-value pair has co-occurred with every other attribute-value pair. Since only one record has been observed, all of the counts equal 1.

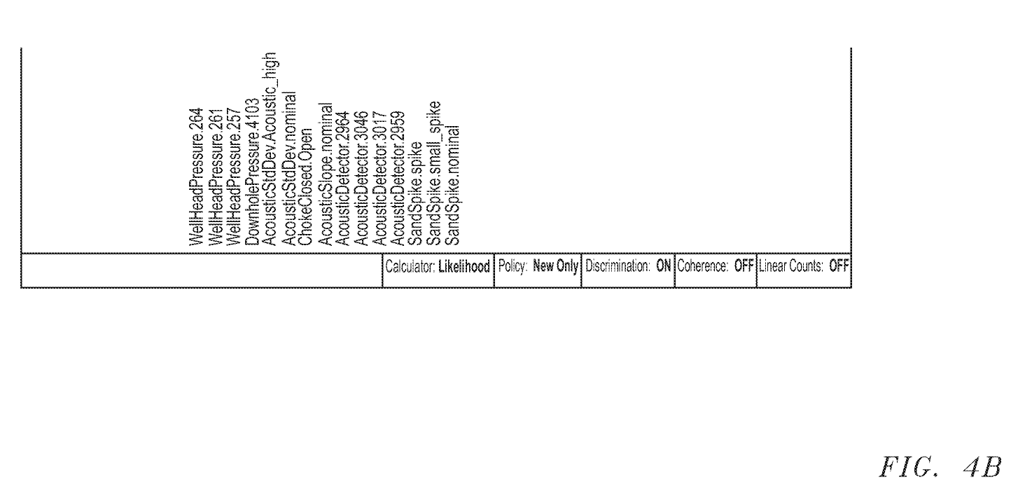

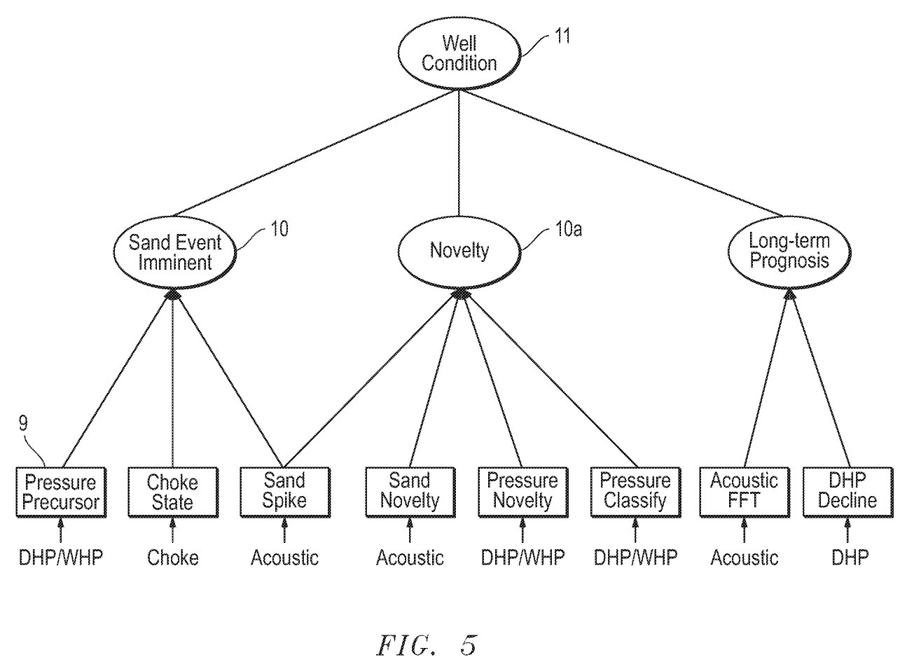

As more data are read, the number of attributes stored in the memory—and the co-occurrence counts—change. FIG. 4 illustrates a memory after four records have been read. Notice that attribute co-occurrence counts 8 have changed and range from zero which means that the two attribute-value pairs have never occurred together to four which means that the attribute-value pairs have occurred together four times.

Having created a memory through this ‘training’ process, the memory may be queried with new observations to classify them or to predict the values of missing attributes. By providing feedback on the quality of the classification or predictions, the memory can learn new patterns or positively or negatively reinforce past observations. This continuous learning process is a critical differentiator from neural networks or rule-based systems.

Most importantly, associative memories are very good at recognizing patterns like those commonly found in monitoring and surveillance applications. For example, they might store data such as the slope of pressure channel at the onset of an event, the height of a spike in an acoustic channel, and so on. Because these memories can store large amounts of data, the memories can be “imprinted” with as many examples as needed of the patterns that are wished to be recognized.

Concept Graphs

A typical event recognizer uses multiple associative memories; each specialized to recognize a particular kind of pattern. Events in the oil and gas world can be very complex. There might be observed a gradual increase in spikes on an acoustic detector spread out over several days, perhaps accompanied by changes in water content, followed by anomalous downhole pressure values just prior to a sand failure. Concept graphs provide a means for fusing results from multiple recognizers

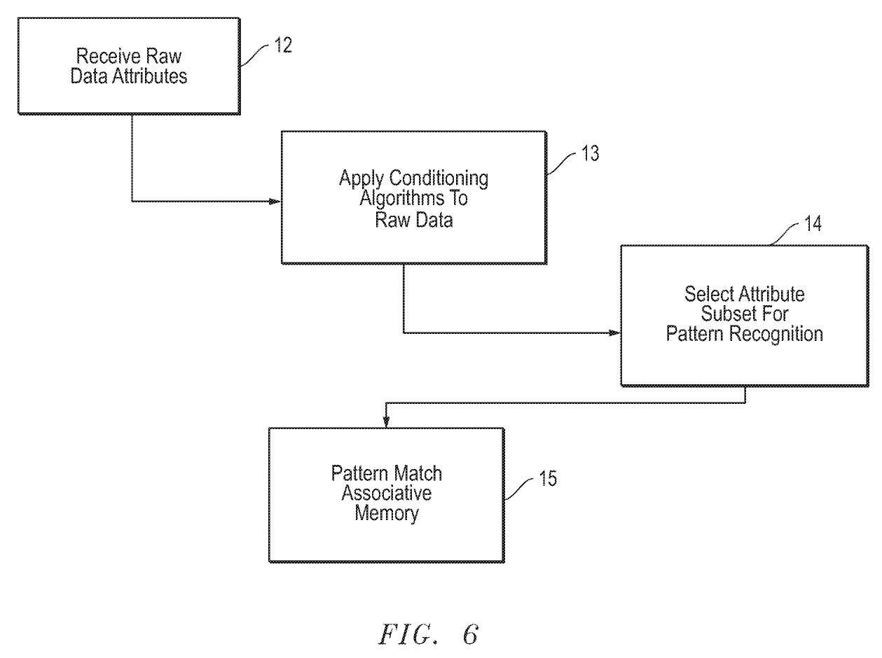

Concept graphs are an implementation in software of “bottom-up” thinking. When faced with large amounts of low-level data about the world, people typically draw inferences by aggregating individual data points to draw intermediate and then high-level conclusions. FIG. 5 represents a concept graph used to monitor for sand production in oil wells. The rectangular nodes at the bottom of the graph represent associative memory detectors; each specialized to perform a particular function. For example, the Pressure Precursor 9 node monitors downhole and wellhead pressures and trends to detect anomalies that often occur at the onset of a sand failure.

The data from each of the low-level pattern detection nodes flow up the graph and are aggregated at the mid-level of the graph to determine
1. Whether a sand event is imminent 10,
2. Whether the conditions being observed are novel 10a (i.e., conditions which have not been seen before on the well), and
3. Whether the long-term prognosis for the well is good or bad 11.

Event Recognizer Training and Configuration

The discussion below describes how event recognizers can be trained and configured.

An event recognizer's functionality is fundamentally defined by

1. The set of data conditioning algorithms performed on raw data

2. A set of pattern detectors (i.e., associative memories) and

3. A concept graph which specifies how information from the pattern detectors is to be aggregated for event detection.

It is expected that the concept graph for a recognizer type (e.g., a sand recognizer for Gulf of Mexico deep-water wells) will be a template that can be specialized by varying the way associative memories are trained. Accordingly, a library of recognizer templates is envisioned that an oil company's staff would be able to adapt for different wells by training various software agents to the actual conditions for a particular well.

Similarly, the definition of conditioning algorithms for processing raw data is effectively fixed at the time a recognizer is initially specified. It would not be appropriate to redefine the conditioning strategy for a recognizer because a change of this sort will change the recognizer's behavior in perhaps unexpected ways. Conditioning strategies are specified in a schema for the recognizer.

Given a concept graph, making a recognizer specialized to a particular well involves training a set of associative memory agents using data from the well to be monitored. Most, but not all of the agents used for sand recognition are two-response memories:

1. One memory compartment is trained with examples of normal behavior for the well being monitored

2. The other memory compartment is trained with examples of abnormal behavior observed in wells different from the well being monitored.

The abnormal behavior memory training data are the same from one-well to another since the abnormal response contains examples of bad well behavior seen on various wells. This capability is present because the signal conditioning step can develop both absolute attributes of the data and relative attributes. For example, both the absolute standard deviation of a signal can be computed and used on a particular well and the fractional standard deviation can be used and applied to a different well. To “jump-start” the process of configuring a recognizer, a method has been developed for packaging a set of partially trained memories so they can be re-used. An agent pack for a recognizer typically contains memories whose abnormal responses have been trained. To finish the training process, the well has only to be trained for normal memory compartments.

There is one additional training issue. An event recognizer also includes novelty memories. A novelty memory distinguishes between conditions which have been observed in a memory and those conditions which have not been seen in the well (novel conditions). A novelty memory is trained by storing in the memory examples of how the well normally behaves.

Table 1 summarizes the event recognizer training process.

TABLE 1
Event Recognizer (ER) Training Process

| Step | Procedure | Notes |
|---|---|---|
| Gather the materials to train | 1. Obtain a graphical picture of | |
| | the ER concept graph for | |
| | reference | |
| | 2. Obtain the agent pack for the | |
| | ER to be trained. | |
| | 3. Identify a training set. Identify | Note that raw data and the data |
| | “normal” conditions. | tags must be consistent with the |
| | | ER input specifications. |
| | 4. Ensure that the conditioning | This is an Agent builder |
| | schema for the ER is available in | configuration issue. |
| | Agent builder. | |
| Train the agents using Agent | 1. Condition the training set file | Perform this function using Agent |
| builder | | builder and the proper |
| | | conditioning schema. |
| | 2. Import the ER agent pack | Agent builder function |
| | 3. Train the normal side of each | Representative regions of normal |
| | 2 response memory | behavior are used for this |
| | | training. |
| | 4. Train the novelty memories for | Typically, representative regions |
| | the ER. | of normal behavior are used. |
| Deploy the recognizer | 1. Deploy the recognizer | |
| Periodically update the novelty | 1. On an as-needed basis, | The definition of “as-needed” is |
| memories | identify additional regions of | to-be-determined (TBD). |
| | normal behavior that need to be | NOTE: the steps required for |
| | added to the novelty memories | updating the novelty memories is |
| | | essentially the same as the initial |
| | | training process. |

The following discussion relates further to using the associative memory and concept graphs to develop event recognizers that can diagnose conditions on many differing data streams whether coming from production data, artificial lift data, or data from auxiliary machinery on off-shore oil platforms.

### OTHER FEATURES OF THE INVENTION

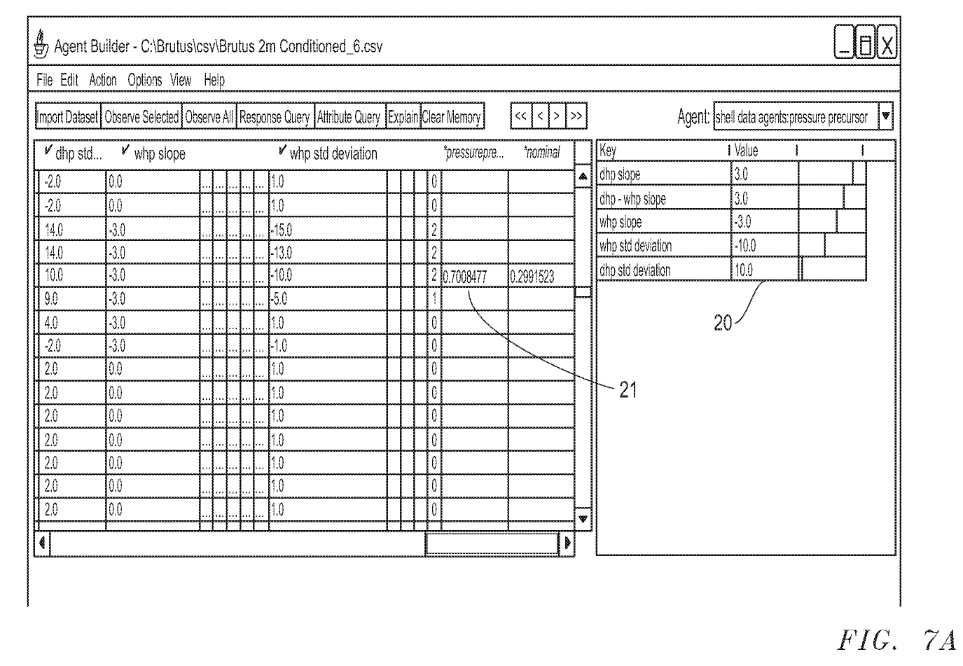

Data conditioning involves the application of numerical algorithms to a stream of raw data. The discussion above summarized a set of data conditioning algorithms. The process is illustrated in FIG. 6.

Raw data attributes 12 may include data such as choke position, downhole pressure, downhole temperature, and so on.

To apply conditioning algorithms to raw data 13, numerical routines are executed to generate additional data values. For example, the slope of the down hole pressure may be calculated. This slope value becomes a new data value that can be used as an input to the associative memory based pattern detector. Given an input set of, for example, 6 raw data values, many more data attributes may be generated.

An associative memory detector typically requires only a subset 14 of the large number of data attributes resulting from data conditioning. In many cases, a detector uses the derived (i.e., conditioned) attributes and none of the raw attributes. This selected set of attributes is passed to the associative memory for pattern recognition 15.

Agent builder, the tool used for training associative memory detectors, provides a means for the creator of a detector to specify which data conditioning algorithms should be applied to each raw attribute. These conditioning specifications are stored in an XML “schema” file. Information from the XML schema file generated by Agent builder is used by the deployed event recognizers.

Many of the data conditioning algorithms require a “lead-in” period since values are dynamically calculated (and re-calculated) over time. For example, as currently implemented the baseline value for a data channel requires that 200 records be seen. Until the “lead-in” time for conditioning is reached, detectors may not have enough attribute values to classify conditions accurately.

The lead-in time required for a recognizer to begin working effectively is a separate and distinct issue from the memory training process.

Associative memories are typically used to discriminate between “nominal” conditions and conditions that indicate a problem of some sort. For example, the pressure precursor detector is designed to recognize pressure anomalies that often occur on the order of 15-20 minutes prior to a significant sand spike. The pressure precursor memory has two response categories: ‘nominal’ and ‘pressure precursor’. The pressure precursor detector is trained as follows:
Data representative of pressure precursor conditions observed in a variety of wells is stored in the pressure precursor response category.
Data representative of normal conditions for the well being monitored is stored in the ‘nominal’ response.

When the detector is deployed, the input data record (e.g., raw and/or conditioned attributes) is compared to each response category to determine whether the current conditions are most like nominal or most like a pressure precursor.

Novelty memories provide a means to distinguish between conditions that have been observed before in a well and new, novel conditions. A condition is defined by a set of values for data attributes (raw or conditioned) and the relationships between these attributes. Since an associative memory agent is trained by storing data in the memory's co-occurrence matrix, the memory can be used for distinguishing between data already observed and novel data. Novel data merits the operator's attention because it may indicate that conditions in the monitored well have changed. Table 2 illustrates the principles underlying novelty memories. In this simple example, three records are read into a memory, with each record containing a value for choke position, slope of the downhole temperature, slope of the downhole pressure, slope of the wellhead temperature, and wellhead pressure.

TABLE 2
Previously Observed Conditions

| | Choke | DHT | DHP | WHT | |
|---|---|---|---|---|---|
| Record | Position | Slope | Slope | Slope | WHP |
| Record 1 | Stable | Flat | Flat | Flat | Flat |
| Record 2 | Stable | Flat | Flat | Slight | Flat |
| | | | | increase | |
| Record 3 | Stable | Flat | Sharp | Flat | Moderate |
| | | | increase | | decrease |

Table 3 illustrates how a novelty memory discriminates between previously observed conditions and new conditions.
Record 4 is NOT novel because the exact conditions in the data set already exist in the memory.
Record 5 IS novel because the DHP slope has a value of “Slight increase” while other values are Flat or Stable. This particular combination of values does not exist in the memory.
Record 6 IS novel because a value of “Moderate increase” has never been observed for DHT Slope

TABLE 3
Novelty Determination

| | | DHT | DHP | WHT | | |
|---|---|---|---|---|---|---|
| Record | Choke | Slope | Slope | Slope | WHP | Novel? |
| Record 4 | Stable | Flat | Flat | Flat | Flat | No |
| Record 5 | Stable | Flat | Sharp | Flat | Flat | Yes |
| | | | increase | | | |
| Record 6 | Stable | Moderate | Flat | Flat | Fiat | Yes |
| | | increase | | | | |

Some detectors are specialized for use with a particular well and others are not. The following categories of detectors are currently included in event recognizers.

TABLE 4
Agent Categories

| Class | Description | Comments |
|---|---|---|
| Shared agent | A shared detector can be used | These do not need to be |
| | on any well | customized. |
| Classification agent | These detectors discriminate | The ‘nominal’ response in the |
| | between nominal and abnormal | memory is trained using data |
| | conditions | from the well being monitored. |
| | | The ‘abnormal’ response is |
| | | trained using data from other |
| | | wells that have exhibited |
| | | abnormal behavior. |
| Novelty agent | These detectors distinguish | These memories are trained |
| | between previously observed | using data from the well being |
| | and newly observed conditions. | monitored. |

An event detector can also learn from its previous behavior. For example, assume that a novelty detector has been trained using data representative of known-to-be-normal conditions. In the future, the well's behavior changes and the new conditions are flagged by the recognizer as novel. If operators determine that these new conditions are normal given the evolution in the well's behavior, data representative of the new, normal conditions can be added to the novelty memory, thereby teaching the memory.

Specific detectors included in recognizers are illustrative of how agents can be built up from data sets for determining sand production in wells. Application to other conditions is straightforward based on the principles below.

TABLE 5
Detector Set for Current Event Recognizer Examples

| Detector name | Type | Training Notes | Notes |
|---|---|---|---|
| Choke State | Shared | | Does not need to be |
| | | | specialized for a |
| | | | particular well. Monitors |
| | | | choke state. |
| Pressure State | Classification | Train the nominal | Detects pressure |
| | | response using data | conditions that may |
| | | from the well being | precede a sand burst. |
| | | monitored. Use the | |
| | | ‘Pressure Precursor’ | |
| | | schema | |
| Sand State | Classification | Train the nominal | Detects significant |
| | | response using data | spikes in the acoustic |
| | | from the well being | channel. |
| | | monitored. Use the | |
| | | ‘Sand Spike’ schema | |
| Pressure Novelty | Novelty | Train the memory using | Distinguishes between |
| | | data from the well being | previously observed and |
| | | monitored. Use the | new conditions in the |
| | | ‘Pressure Novelty’ | pressure and |
| | | schema. | temperature domain. |
| Pressure Anomaly | Classification | Train the nominal | Used to determine |
| | | response using data | whether a novel |
| | | from the well being | pressure condition is |
| | | monitored. Use the | similar to known |
| | | ‘Pressure Classify’ | nominal conditions or to |
| | | schema | known conditions of |
| | | | concern. |
| Sand Novelty | Novelty | Train the memory using | Distinguishes between |
| | | data from the well being | previously observed and |
| | | monitored. Use the | new conditions in the |
| | | ‘Sand Novelty’ schema. | acoustic channel. |

The concept graph provides a means for integrating the results from multiple pattern detectors so that an aggregate interpretation of well state can be determined. FIG. 5 illustrates the structure of a concept graph for sand monitoring.

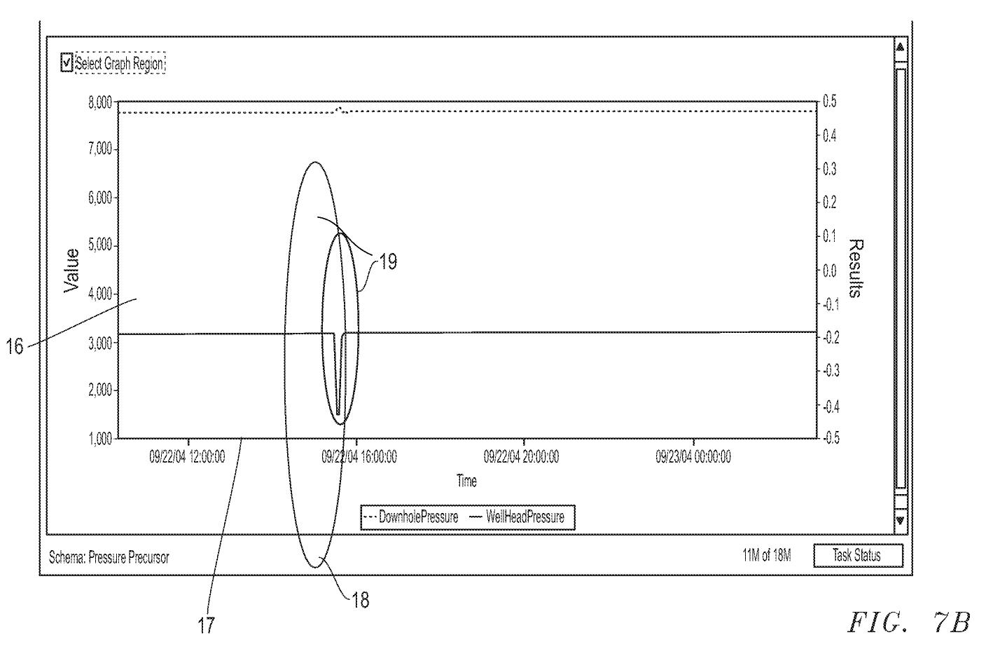

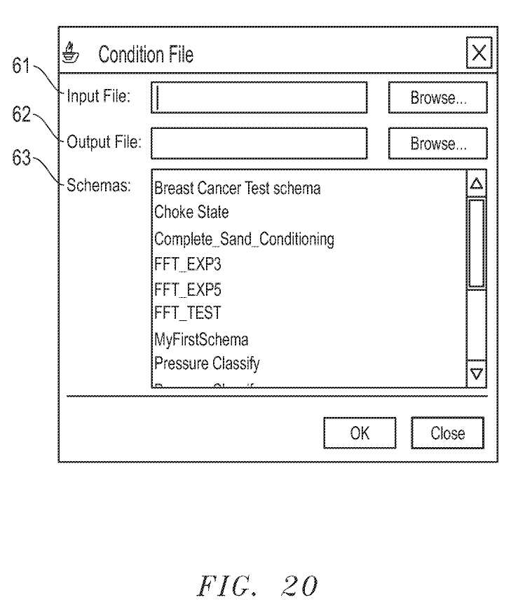

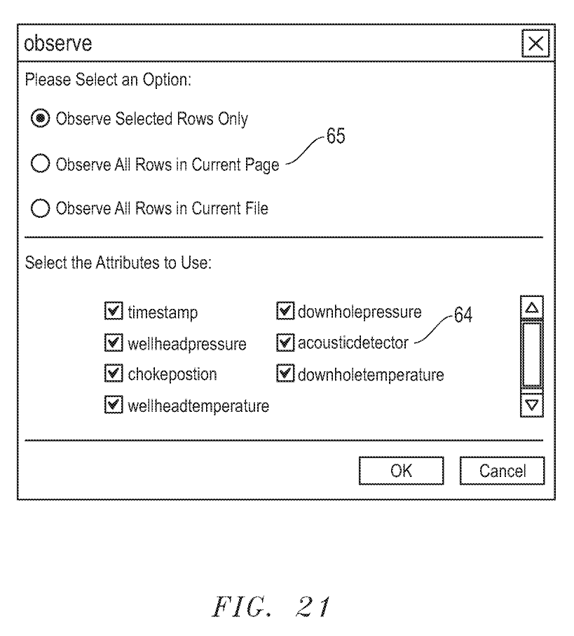

Associative memories provide a means for explaining its results in terms of the attributes which most strongly contribute to the classification of a condition. FIG. 7 illustrates this capability using an example from Agent builder. In this case a pressure precursor memory is being used to assess pressure conditions in a well. The region within the red oval 19 is the focus, a region where WHP drops sharply and DHP rises modestly. Notice that the likelihood that this condition is a pressure precursor is >0.70 21. The top right quadrant of the FIG. 20 illustrates the memory's explanation of this classification. The DHP Slope (with a value of 3, a sharp increase) is the attribute which most strongly influenced the classification. The second most important attribute was the slope of the DHP minus WHP (also with a value of 3). Other contributing attributes include the WHP slope and the WHP and DHP standard deviations, a measure of the degree to which the WHP and DHP deviate from a baseline value.

An event recognizer can be reconfigured in two ways:

1. By re-training the associative memory detectors that comprise the recognizer. This re-training might include (a) changing data conditioning strategies or (b) changing the data set used for training a memory's responses.

2. By changing the structure of the concept graph, perhaps by even adding or removing detectors from the graph.

The Role of the Agent Builder:

Of paramount importance for the functionality embodied by this invention is the software program called the Agent builder. This feature enables personnel who are not intimately knowledgeable about the software of the associative memories to use the agents to monitor production and to diagnose problematic behavior on wells. The agent builder makes the intelligent agent software “user friendly.” The discussion below elucidates the capabilities of the agent builder and explains how it is to be used by oil company personnel to construct agents for their purposes.

The discussion below describes the configuration and uses of an agent builder, a tool used for training pattern detectors used in event recognizers.

1. Agent Builder Functions

Agent builder is a tool for training and testing pattern detectors—the associative memory components that are composed to make event recognizers. Concept graphs provide a means for fusing results from multiple detectors. A detector is an individual associative memory while a recognizer fuses results from multiple detectors.

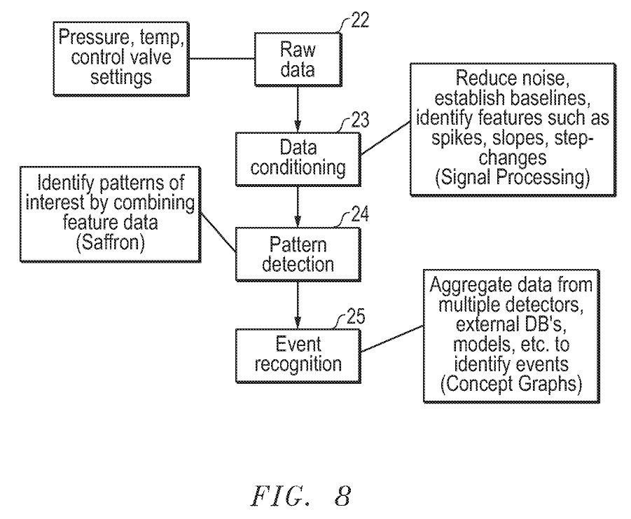

An event recognizer functions by processing data in the manner shown in FIG. 8. As currently implement, agent builder supports some of the functions associated with this processing flow. Specifically agent builder enables users to
specify how raw data 22 should be conditioned 23
train pattern detectors 24
test pattern detectors.

1.1 Basic Tool Layout

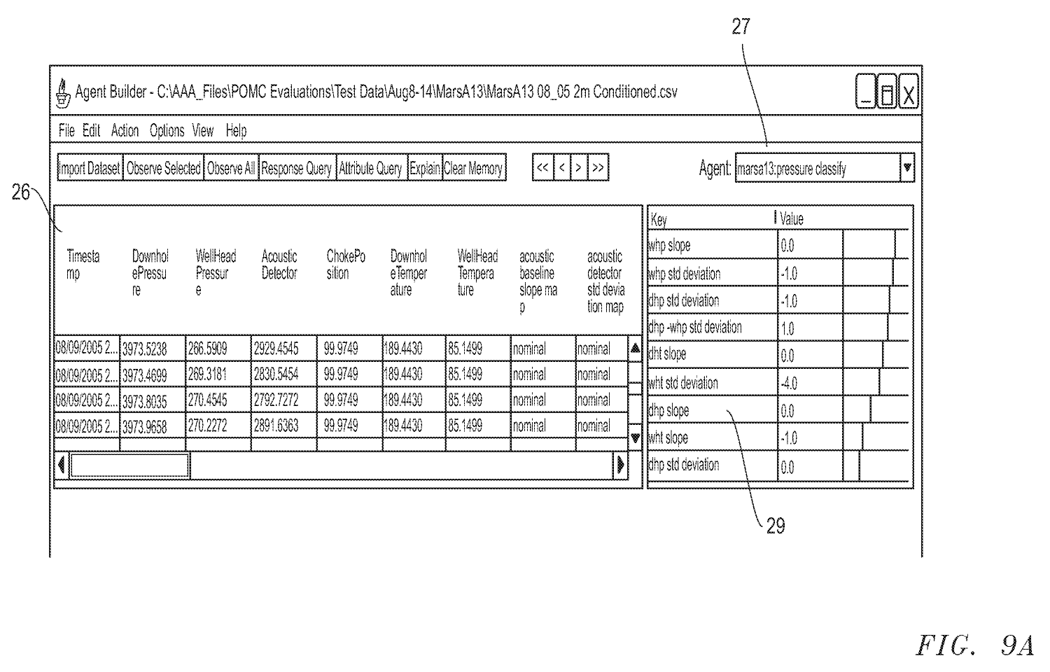

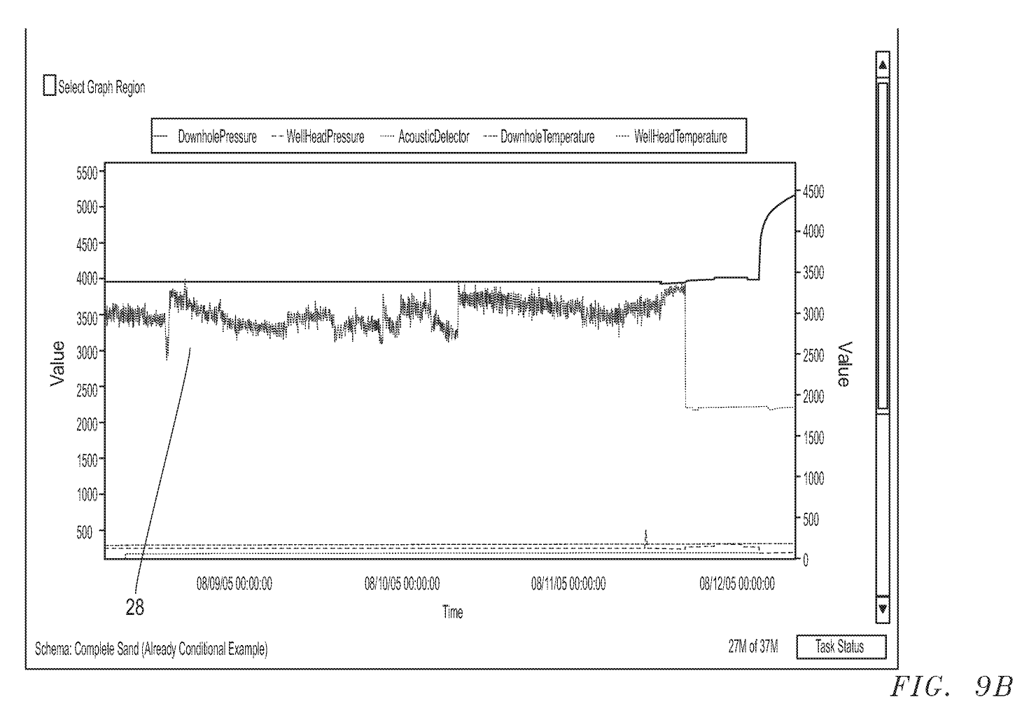

As shown in FIG. 9, agent builder has three basic display panes. The Textual Data Display 26 is a scrolling window for displaying, in text format, data that the user is manipulating. The Graphical Display 28 provides a means for viewing some, or all, of the data shown in the textual display area. The Graphical Display has a number of functions which are described later in this document. The Associative memory Explanation 29 pane is used for displaying explanations of query results. Note that the currently selected agent (detector) is shown in the top right hand corner of the display in the pull-down selector box 27.

1.1.1 Main Menu Items

Agent builder has six main menu items: File, Edit, Action, Options, View, and Help. As context for understanding the functions provided by the main menu, please note the following definitions.
Data set: a file of data, such as pressure, temperature, and acoustic sensor readings.
Schema: a description of the data in the file and conditioning steps to be performed on this data.
Agent: a pattern detector. Equivalently, an Associative memory.
Page: a subset of data in a data set. Because a data set may be arbitrarily large (10's or 100's of thousands of records) and computer memory is finite, agent builder manages data in terms of adjustable pages which define how much data is viewable at one time. The page size is the number of records which are visible at once. Page size is user configurable.

The functions provided through the main menu items are defined in Table 6.

TABLE 6
Agent builder Menu Functions

| Main Menu Item | Function | Description |
|---|---|---|
| File | Import data set | Typically performed to either train or test a detector |
| | Import schema | Enables a schema defined elsewhere to be |
| | | imported into the user's version of agent builder. |
| | Import agent | Enables an agent (i.e., detector) created elsewhere |
| | | to be included in the user's configuration of agent |
| | | builder |
| | Find events | A simple tool for finding out-of-bounds conditions in |
| | | a data file |
| | Agent Manager | Provides a means for creating, documenting, and |
| | | deleting agents (i.e., detectors) |
| | Schema Manager | Provides a means for creating, editing and deleting |
| | | schemas |
| | Close | Used to close the current file |
| | Export | Used to save the current file, or a portion of the file, |
| | | in a comma separated variable (.CSV) format |
| | Exit | Quit agent builder |
| Edit | Configuration Location | Allows for an alternative configuration file to be |
| | | selected (such as a shared file on the network). |
| | | Primarily designed to allow users to easily load up |
| | | a different configuration. |
| | Select All | Select all the rows in the current textual display |
| | Search | A simple tool for searching the current file for |
| | | records which match user-specified conditions. |
| Action | Observe | Save records from the current file into a associative |
| | | memory. The user may select all or some of the |
| | | records in the current file |
| | Forget | Delete records from the current file from a |
| | | associative memory. The user may select all or |
| | | some of the records in the current file. |
| | Novelty query | Perform a novelty query. The user may select all |
| | | or some of the records in the current file. |
| | Response query | Perform a response query. The user may select all |
| | | or some of the records in the current file. |
| | Attribute query | Perform an attribute query. The user may select all |
| | | or some of the records in the current file. |
| | Explain | Explain the results from a query performed on a |
| | | single record. |
| | Explain report | Runs “explains” on every record in the current file |
| | | for each response in the current agent. A new CSV |
| | | file will be generated for each response containing |
| | | the raw data as well as explains for each attribute. |
| | Clear memory | Remove all data from the currently selected |
| | | memory (i.e., agent/detector) |
| | Go To | View a specified page or record number in the |
| | | current data file. |
| Options | | Selected options are shown with a check-mark |
| | Likelihood Calculator | Use Associative memory's Likelihood Calculator, |
| | | the most commonly used calculator |
| | Experience Calculator | Use Associative memory's Experience Calculator |
| | Factor Discrimination | Employ discrimination when training or processing |
| | | queries, a commonly used option. |
| | Factor Coherence | Employ coherence when training or processing |
| | | queries. |
| | Factor linear counts | Employ linear counts when training or processing |
| | | queries. |
| | Observe policy | All: observe all records |
| | | New only: observe new records only |
| | | Existence: observe existing records only |
| | Page size | Specify a page size. On modestly sized |
| | | computers, agent builder performs well with page |
| | | sizes of 1000-2000 and poorly with page sizes of |
| | | 10,000+. Users should experiment with various |
| | | page sizes. |
| | Record number | For files which lack time stamps, this function |
| | conversion | provides a way to convert record numbers into time |
| | | stamps. |
| View | Graph properties | Display the graph properties configuration window. |
| | Show graph | When checked, the graph displays data from the |
| | | current page. When unchecked, no data is |
| | | displayed. |
| | Show context console | Displays a console window that will display the |
| | | contexts that are being used for observation or |
| | | queries. (This is more of a debugging tool) |
| | Agent directory | Displays a hierarchical view of the agents defined |
| | | in the Associative memory persistence space. |

1.2 Short-Cut Buttons, Scrolling, and Agent Selection

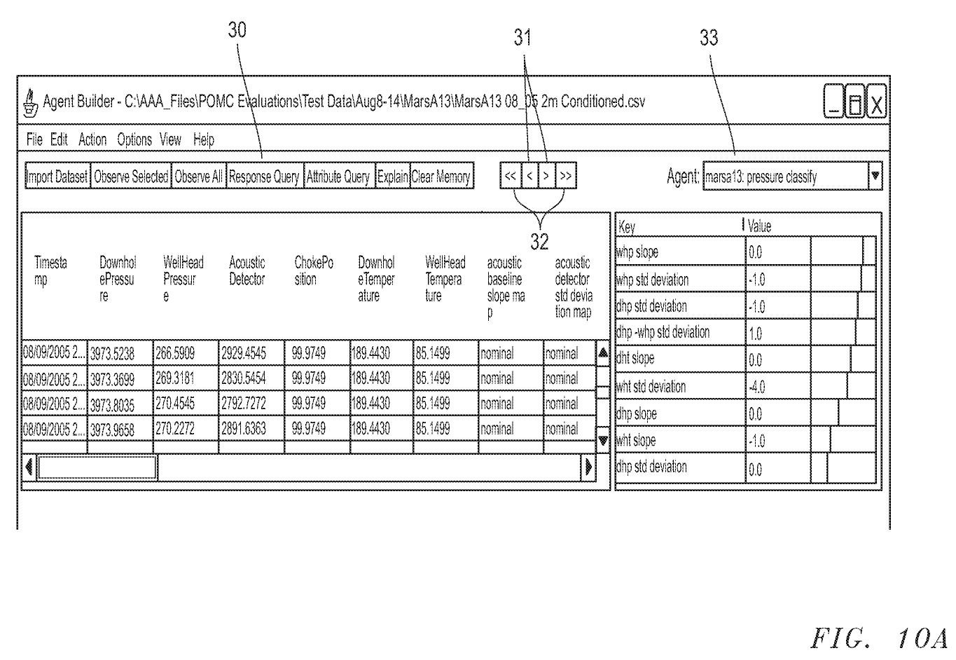

As shown in FIG. 10, agent builder displays frequently used menu functions as buttons just below the menu bar 30. The functions provided by these buttons are exactly the same as their corresponding menu items.

Note the right-and-left arrow buttons just to the right of the menu short-cuts 31, 32. These buttons allow the user to scroll backwards and forwards through a file either a page at a time or by a fraction of a page (˜⅓ of a page increments). The double arrows (“<<” and “>>”) 32 perform page-by-page scrolling; the single arrows (“<” and “>”) 31 perform page increment scrolling.

Also, the pull-down selector at the top-right hand corner of the display 33 specifies which memory is being used for training and testing.

1.3 Agent Manager

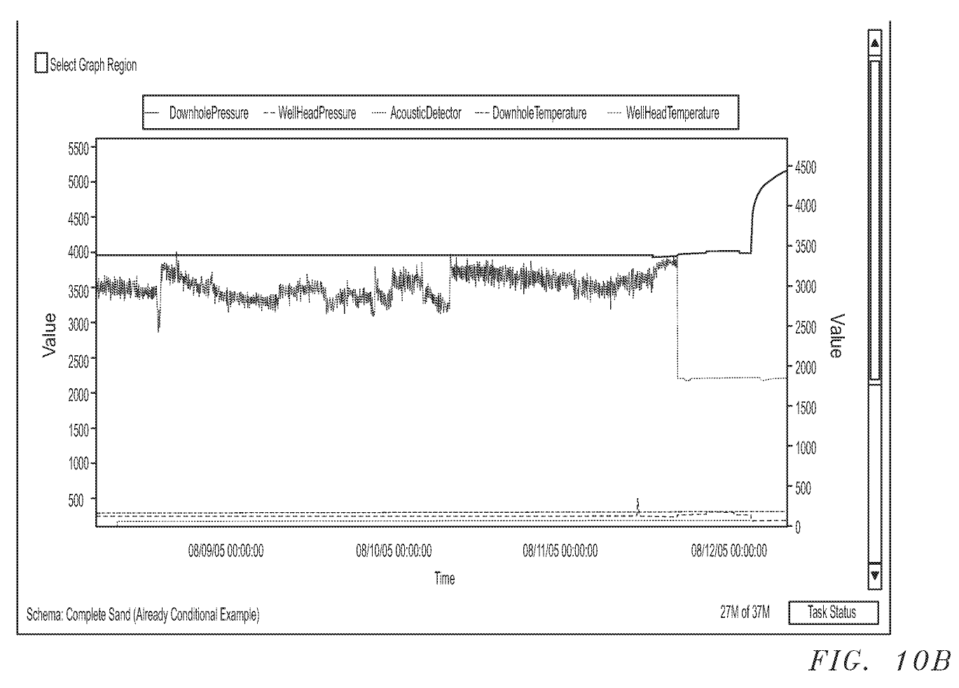

The agent Manager provides a means to create, edit, and manage agents. FIG. 11 illustrates the top-level agent Manager Control panel. This display is invoked from the menu bar by specifying File □ agent Manager. The functions provided by agent Manager include
Create New: create a new agent 34.
Edit agent 35: modify the descriptive information for an agent. NOTE that this function does NOT affect how the agent is trained.
Delete agent 36: remove the agent itself permanently.
Clear agent 37: remove all information within an agent, but keep the agent. This is equivalent to reinitializing the agent to the status of a “blank slate”.
View agent Log 38: display a text file which describes how the agent was trained. This file contains information about the specific records in specific files which were used to train the recognizer.
Export agent 39: save the selected agent(s) in a format which will enable them to be imported by another user.

1.4 Schema Manager

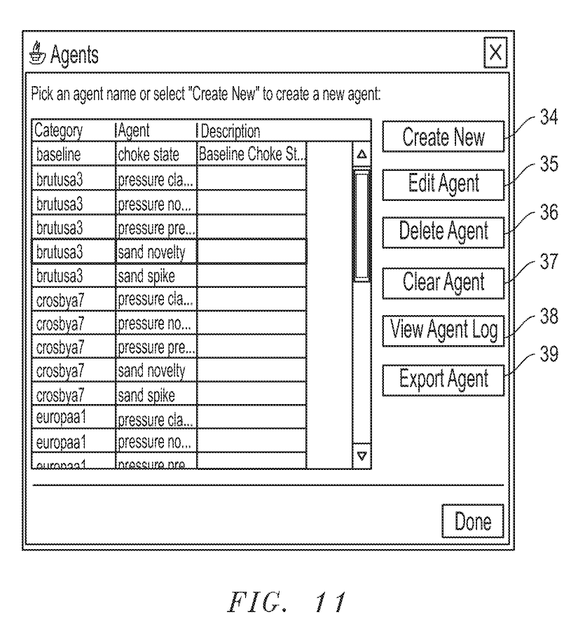

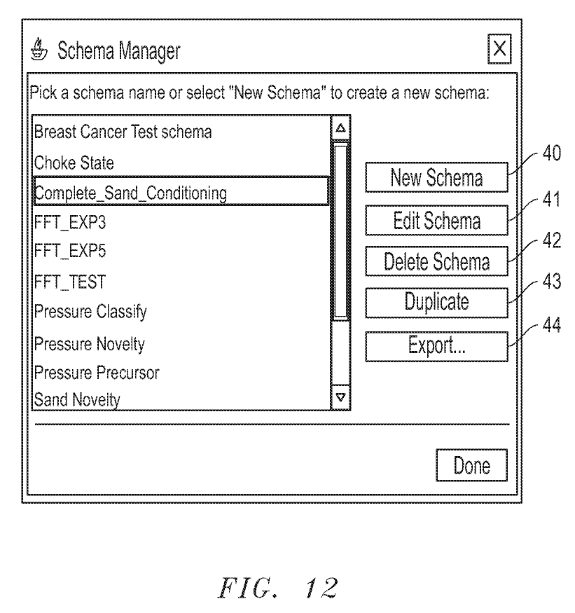

The Schema Manager provides functions to create, edit, and modify the schemas associated with an agent. FIG. 12 is the top-level control for the Schema Manager. This function is invoked from the menu bar by following File F Schema Manager. The following capabilities are provided:
New Schema: Create a new schema 40,
Edit Schema: Edit an existing schema 41,
Delete Schema: Remove a schema permanently 42,
Duplicate: Make a copy of the currently selected schema 43, and
Export: Export a schema so that it can be imported by another user 44.

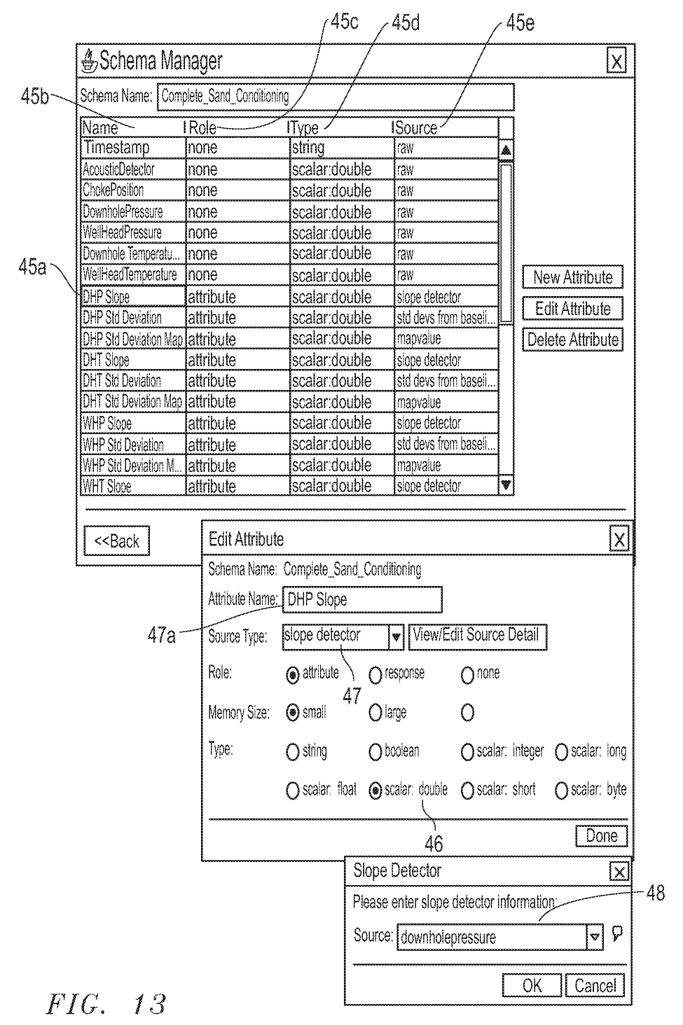

FIG. 13 is a drill-down view of the Edit Schema function. In this example, the user has selected Edit Schema from the top-level control panel and is currently editing an attribute (“DHP Slope” [45a]. This figure illustrates a number of relevant points about schemas.

The schema has a number of attributes, as shown in the top panel 45. Each attribute has Name 45b, Role 45c, Type 45d, and Source 45e.
Name 45b is the name for the attribute
Role 45c is the function served by an attribute. An attribute with a role of “None” is not employed by the recognizer that uses the schema; attributes with a role of “Attribute” are used by the recognizer.
Type 45d is the attribute's data type
Source 45e specifies whether the attribute is included as an input data attribute (“raw”) or whether the attribute is calculated using a data conditioning algorithm.

In FIG. 13, DHP Slope 47a is a double (numeric) 46 attribute that is used by the recognizer. The value of DHP Slope is calculated by applying a slope detector 47 algorithm to the downhole pressure attribute 48. This information is visible in the lower two panels of the figure.

1.5 Using the Graphical Display

The graphical display enables the user to display data from the current file, with considerable control over which data is shown. Note, however, that . . .
The graphical display and the textual display are “slaved” to the page size. For example, if the page size is set to 1000, then the graph will show data from 1000 records at a time.
The textual and graphical displays are “slaved” to each other. Scrolling backwards or forwards (either incrementally or on a page-by-page basis) causes the data shown in the textual and graphical displays to change equivalently.
The graphical display has a left-and-right hand display scale axis.
The graphical display is sensitive to the number of data items displayed and to page size.

1.5.1 The Graphical Display Properties Window

To access the graphical properties window, either
Select View □ Graph Properties from the menu bar or
Right click within the graph and select Graph Properties . . .

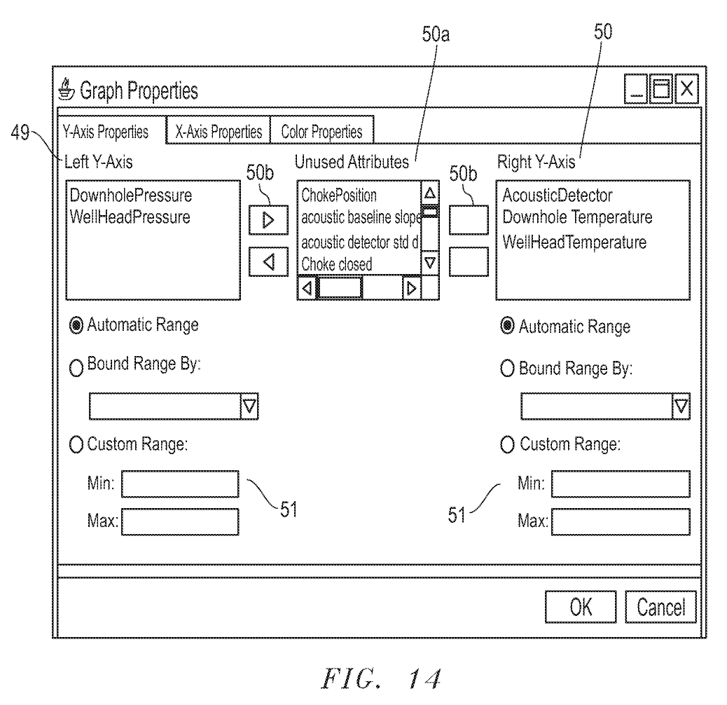

FIG. 14 illustrates configuration options for the graph's Y-axis. Attributes can be shown on the left-axis scale 49, the right-axis scale 50, or they can be hidden (Unused Attributes [50a]. Select one or more attributes and use the arrow buttons (“>”, “<”) 50b to move the attributes from one column to another.

The bottom portion of the window 51 provides a means for specifying the scales to be used on the left and right display scales. Automatic range means that agent builder will calculate the appropriate scale based on the min/max values of data to be displayed on that scale. Bound Range By enables the user to specify which particular attribute should be used for determining the scales min/max. Custom Range enables the user to specify absolute min/max ranges.

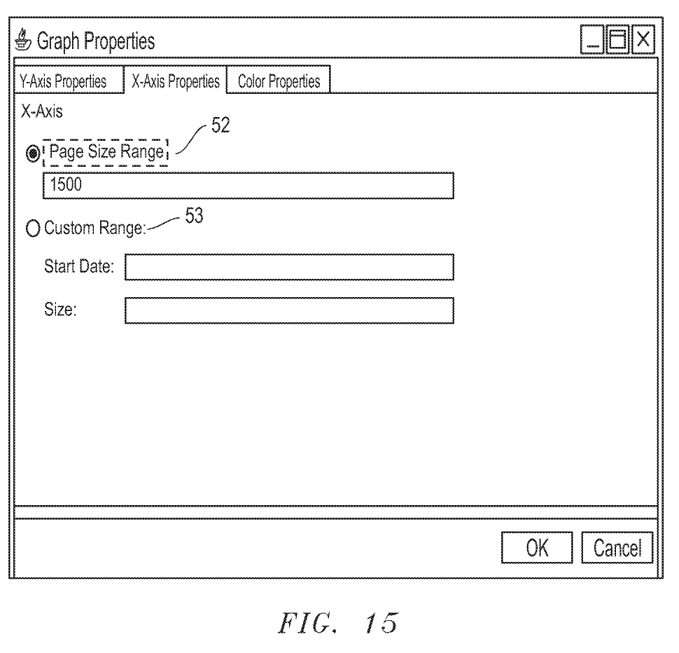

FIG. 15 illustrates configuration options for the graph's X-axis.
Page size range 52 provides an alternative means for setting page size
Custom range 53 allows the x axis to be defined using a start time and a size (number of records to display)

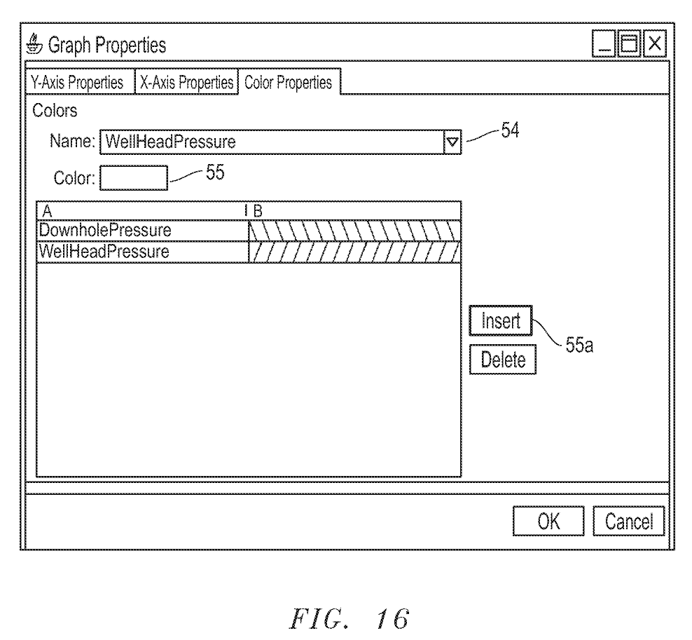

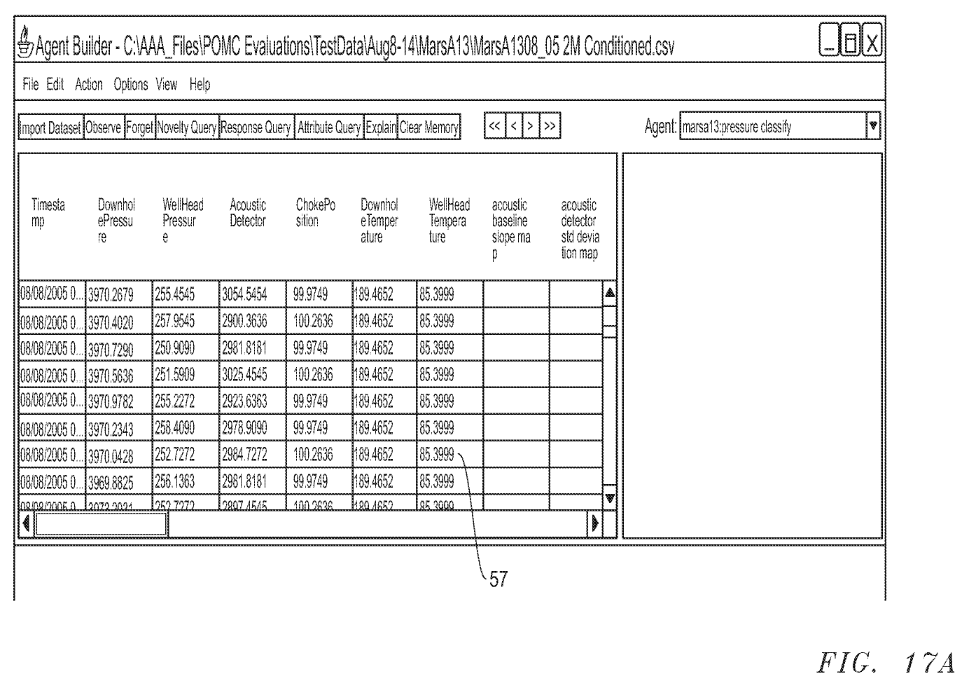

FIG. 16 illustrates configuration options for setting colors of individual attributes on the graph. Note that agent builder will automatically select colors for the attributes being displayed—but the user may not like agent builder's palette. The color properties tab enables the user to specify the user's own colors for whatever attributes the user wishes. To set the color for an attribute:
Pick an attribute from the “Name” selector pull-down 54.
Click on the “Color” button 55.
Pick a color from the palette and select “OK” on the palette.
Click the “Insert” button 55a on the color properties display.
When the user is finished specifying colors, click the ‘OK’ button.

1.5.2 Selecting Graph Regions

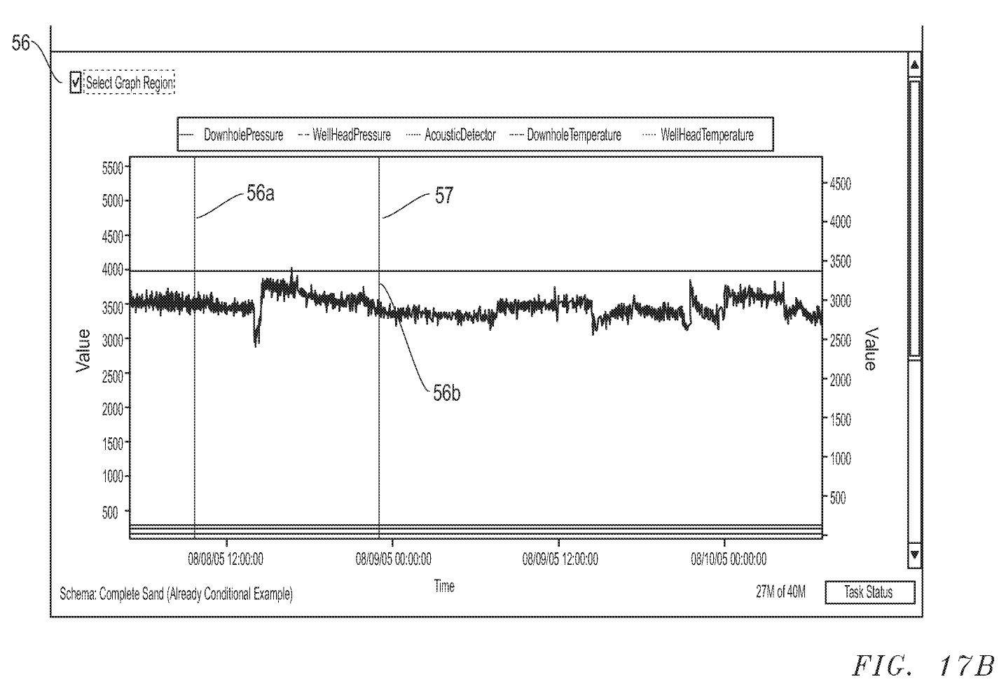

Subsets of data shown in the graphical display can be selected, a feature that can be useful for region of data to be used for training or testing a detector. FIG. 17 illustrates the graph selection function. When the Select Graph Region box 56 is checked, the user may select the left and right-hand sides of a region using the mouse.
Move the mouse into the graph. A vertical line 56a appears. Position this line at the left-hand side of the region to be highlighted. Click left.
Move the mouse and vertical line to the right-hand 56b side of the region to be highlighted. Click right.
The region of interest will be highlighted in both the graph and the textual display 57.

2. Representative Use Cases

The following use cases illustrate typical tasks that may be performed using agent builder.

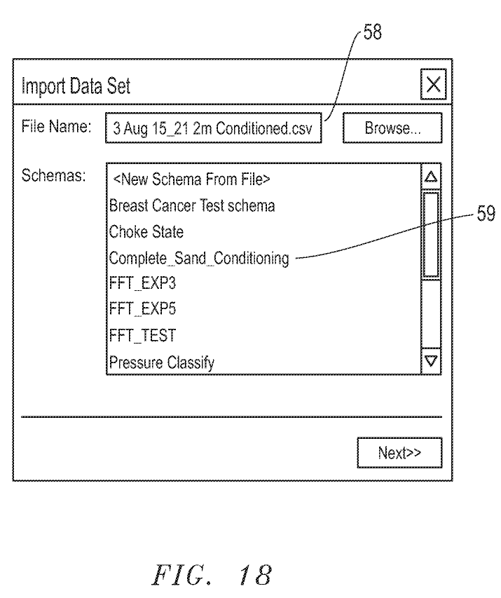

2.1 Configure Agent Builder to Train or Test
Using the pull-down selector in the top right-hand corner of agent builder's main display, select the agent to be trained or tested.
If the agent to be trained or tested does not exist, use agent Manager to create the agent. Then select the agent using the pull-down.
Import a dataset using either the short-cut button on agent builder's main display or the menu bar option File □Import Dataset. As shown in the FIG. 18, the user will need to specify both the file to be imported 58 and the schema 59 to be used when reading the file 58.
If the schema to be used with the file does not exist, select <New Schema from File>. Agent builder will read file header and create a schema which can be edited as needed.
The data set will be imported and will appear in agent builder's textual display pane.

2.2 Define a Schema

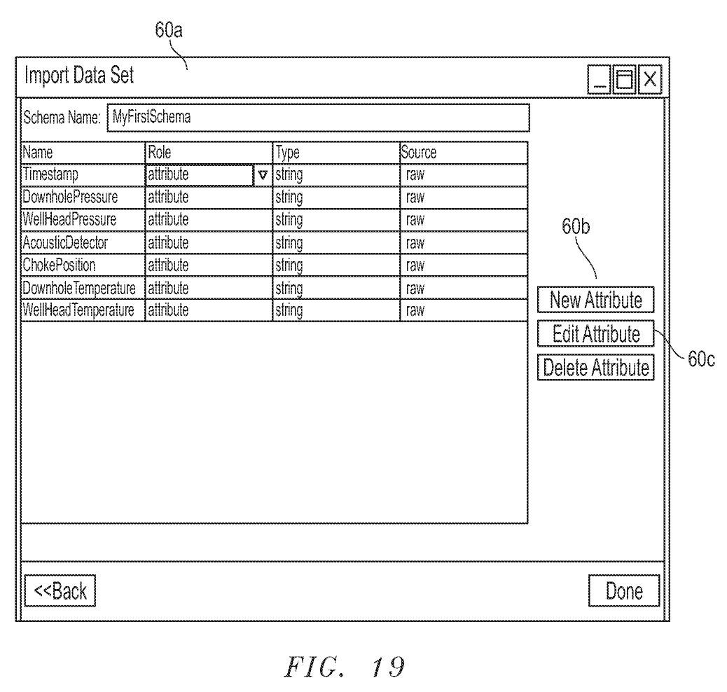

Typically a schema is defined by modifying a file that agent builder has automatically generated. The following use case is illustrative of the process.
Import a dataset which contains raw data and specify that agent builder should create a <New Schema From File>.
Note that agent builder displays the schema editing display 60a shown in FIG. 19. This is the same display described above in the discussion of the Schema Manager.
Use the functions provided by the schema editor to add 60b, edit attributes 60c for the schema.
Select “Done” to save the schema.

2.3 Condition a File

This case assumes that a raw data set exists and that a schema has been created which specifies how raw attributes should be conditioned.
From the file menu, select File □ Condition File. This display shown in FIG. 20 will appear.
Specify . . .
the name of the input file 61 (the data set with raw attributes)
a name for the output file 62 (the data set to contain conditioned attributes)
the schema 63 to be used for conditioning the data.
Click “OK” on the pop-up dialog box and then “Close” from the file conditioning display.

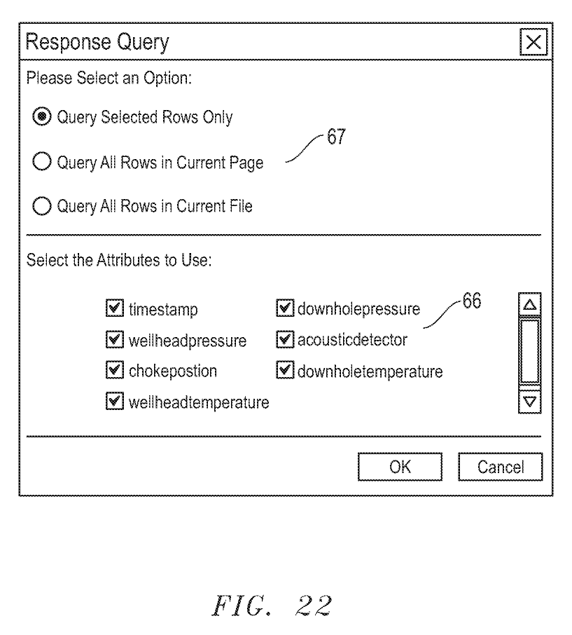

2.4 Train a Detector
Follow the steps described in the case Configure agent builder to Train or Test.
When the file is loaded, select a region of interest that is representative of the well's normal behavior or an abnormal behavior. The user may select this region either from the textual display pane or the graph.
The Observe dialog box will be displayed, as shown in FIG. 21. Note that the user can specify which attributes 64 are to be included for training. Note also the options for selecting training records 65.
The user will be prompted to specify a response for the observation. Remember the response is a category such as “nominal”, “sand”, “hydrate” or some other tag that is appropriate for the agent being trained.
A record of the training performed will be stored in the agent log which is accessed through agent Manager.

2.5 Test a Detector

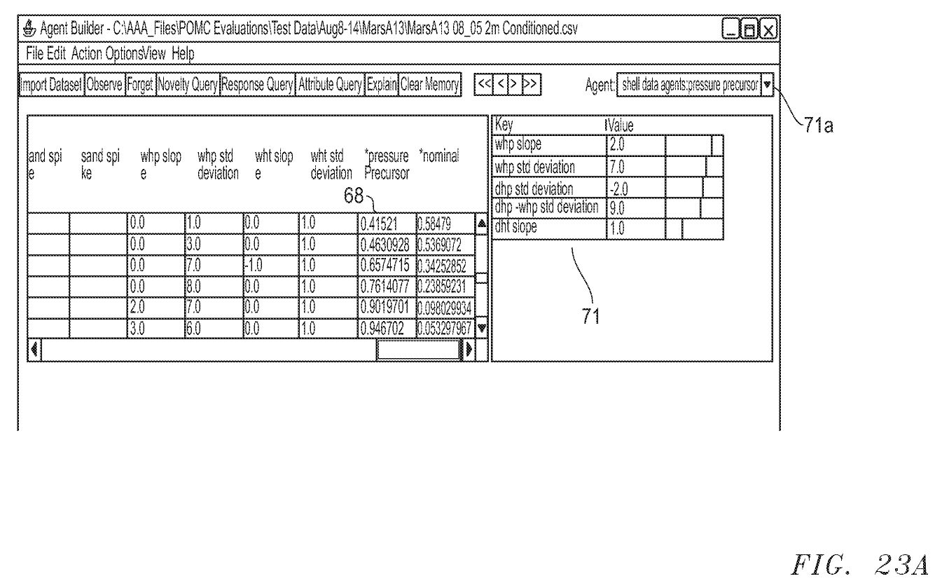

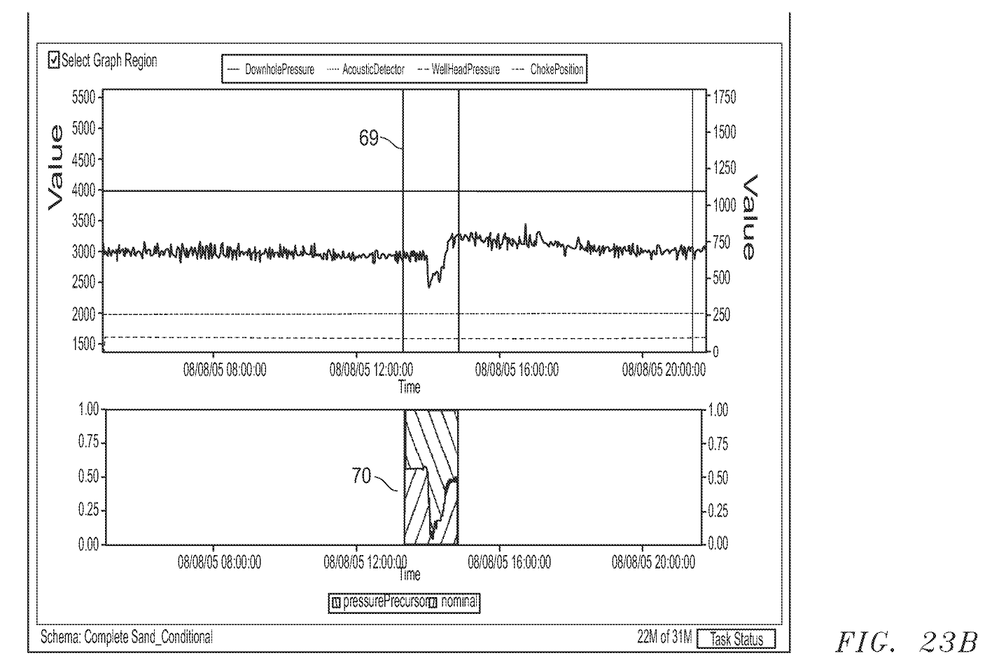

Follow the steps described in the case Configure agent builder to Train or Test.
When the file is loaded, select a region of interest to be tested using either the textual or graphical display.
Select Response Query from the short-cut buttons on top of agent builder's main display. The dialog box illustrated in FIG. 22 will be displayed. Note that the user may specify which attributes 66 are to be used for the query. Note also the options for specify which records are to be used for the query 67.
The results from a response query are shown in FIG. 23. In this case, the user has employed a pressure precursor detector 71a to classify the section of data which is highlighted in the graph 69. Numeric results are shown in the textual display 68 in the right-most columns. Since this agent has two response categories (pressure precursor and nominal), the results show the likelihood that a record is one category or the other.
Note the stacked bar graph below the data graph 70. This stacked graph shows visually that the well's pressure state deviated far from normal midway through the test region.
Finally, note the explanation 71 shown in the top-right hand corner of the display. The explanation shows that, for the record selected in the textual display, both the wellhead and downhole pressures are misbehaving and therefore contributed to the classification of this condition as an anomalous pressure state.

It will be clear and obvious to one skilled in the art that applications of the agent builder, the signal conditioning, the associative memory detectors, and the concept graphs enable this invention to be used for many monitoring and surveillance tasks in the production of oil and gas. Extension of this technique to any of the applications listed below is straightforward once the basic development of the agents has been understood.

The following is a list of applications for which these agents can be applied and are included in the present invention:

Beam Pumping Agents automate the following, calibration, balancing, pump-off control, idle time, card diagnosis, and measurement evaluation. These agents are intended on reducing maintenance and repair costs, reduce downtime, and improve production and reservoir recovery.

Gas-Lift Agents automate the detection, diagnosis, and quality control dealing with gas instability, continuous optimization, and adjustment other problem behaviour of gas-lift wells.

Electrical Submersible Pump Agents automate detection and diagnosis of problematic behaviour of wells using this form of artificial lift.

Progressive Cavity Pump Agents help keep the correct amount of fluid over the pump, address attributes of importance in the management of gas/solids/viscosity. The agents detect and diagnose problematic behavior in wells using PCP lifting equipment.

Plunger Lift Agents automate the determination of the optimal plunger cycle, determine amount of gas and liquid per cycle, and determine when to perform plunger maintenance.

Chemical Injection Agents automate the determination of how much chemical to use, when to treat the well, evaluate the chemical's effectiveness in deliquifying the well and determine when to change from one chemical treatment to another.

Water Injection Agents automate the injection rate and measures performance against a reservoir evaluation tool. There are many attributes that can be monitored to improve performance of water flooding where large amounts of money are being spent.

CO2 Injection Agents automate the optimization of the alternating cycles of water and CO2 into a pattern of injection wells.

Steam Injection Agents automate the steam quality determination in addition to performing the same functions as other Injection Surveillance Agents.

Well Test Agents automate the performance of well tests, determine well test frequency, sequence, duration, and will evaluate the results of well tests.

Automated Surveillance Reporting Agents provide situation reports on individual wells. The agents examine may attributes at the same time to determine whether the well is functioning within normal parameters.

Casing Pressure Agents will automate the surveillance of surface casing pressure and recommend best practices when the MAASP (maximum allowable annular surface pressure) value is approached.

Fluid Level Agents will enable the automatic determination of the following: fluid level, sonic velocity in gas, leak locations, and fluid gradients in gassy wells.

1. A system and method for monitoring processes in the production of oil and gas, comprising intelligent software agents employing associative memory techniques that receive data from sensors in the production environment and from other sources and perform pattern matching operations to identify normal and abnormal behavior of the oil and gas production, and report the behaviors to human operators or other software systems, wherein the abnormal behavior may consist of any behavior of the production processes that is other than the desired behavior of the well, and wherein the intelligent software agents are trained to identify both specific behaviors and behaviors that have never before been observed and recognized in the well.

2. The system and method of claim 1, wherein the processes being monitored are naturally lifted oil and gas, and data from well sensors are being provided to the intelligent software agents.

3. The system and method of claim 1, wherein the process being monitored is an artificial lift means for enhancing oil and gas production from a well, and wherein the intelligent software agents comprise agents selected from a group comprising agents for gas lift, beam pumping, electrical submersible pumps, progressive cavity pumps, plunger lift, chemical injection, water injection, CO2 injection, stem injection, wells test, automated surveillance reporting, casing pressure, and fluid level.

4. A system and method for training intelligent agents to monitor processes in the production of oil and gas, comprising an associative memory and a means for training the associative memory to observe normal behavior and abnormal behavior, wherein the intelligent agents are used with operating software and are supplied with data from the production environment via computer and other electronic means, and wherein the agents report the condition of wells in the state of a production environment to human operators or software systems.

5. The system of claim 4, wherein the agent is trained to monitor any production process for which the data provide representative indications, comprising:
a. the means for training consists of agent building software,
b. the agent building software is fed data from a group comprising the production environment and mathematical models,
c. a person familiar with oil and gas production technologies indicates to the software by means provided in the agent builder those regions of the data that indicate normal operation as well as those regions of the data that indicate abnormal behavior, and
d. the person further indicates to the software the type of misbehavior that is indicated.

6. A system and method for training intelligent agents to monitor processes in the production of oil and gas, comprising an associative memory and a means of training the associative memory to observe normal behavior and abnormal behavior, wherein:
a. the agents are used with operating software,
b. the agents are supplied with data from the production environment via a computer,
c. the agents detect a group of detected attributes of the data stream from the group comprising spikes, steps, slopes, dispersion of values whether periodic or non-periodic, and
d. the agents report the detected attributes to human or other software observing the production environments.

7. The system and method of claim 6, wherein:
a. the training of the associative memory comprises using mathematical tools to create attributes from data from sensors and other data sources;
b. the mathematical tools are taken from a group comprising arithmetic manipulation of the data, statistical processing techniques, signal processing techniques, Fourier transforms, standard deviations, and wavelet transforms; and
c. the created attributes are used with the associative memory to recognize patterns indicative of the behavior of a well's production.

8. The system and method of claim 6, wherein the system further comprises means for operation by persons not skilled in the art of creating software to build agents.

9. A system and method for building intelligent agents to monitor processes in the production of oil and gas, comprising:
a. an associative memory;
b. a means for training the associative memory to observe behavior;
c. means for using a concept graph to integrate results from associative memory queries to indicate important changes and to relate the condition of the production to human operators and to other software systems, the concept graph comprising individual associative memory elements and logic operations that are used to determine the implications to the production environment of event detection by the associative memories.

10. A system and method for building intelligent agents to monitor processes in the production of oil and gas, comprising:
a. an associative memory;
b. means for training the associative memory to observe behavior;
c. libraries of associative memories that have been trained to observe particular abnormal behaviors; and
d. means for applying elements of the libraries to wells different from the well on which the agents were trained.

11. The system and method of claim 7, wherein:
a. the agents use absolute values of the detected attributes from a group comprising pressure, temperature, flow rates, spikes, steps, slopes, and dispersion of values, and all the created attributes, and
b. the created attributes further comprise relative values, the relative value comprising the created attribute divided by a number from a group comprising user defined, software defined mean value, and chosen by another logical process.

12. A system and method for building intelligent agents to monitor process in the production of oil and gas comprising an associative memory and a means of training said memory to observe normal behavior and abnormal behavior, wherein the agents are also trained to determine when well conditions have changed from those conditions under which the agents were originally trained, and to retrain the agents with indicators taken from recent sensor data and other data taken from and about a well.

13. A system and method for building intelligent agents to monitor process in the production of oil and gas comprising an associative memory and a means of training the memory to observe normal behavior and abnormal behavior.
